(19) United States
(12) Patent Application Publication
(10) Pub. No.: US 2021/0369539 A1
(43) Pub. Date: Dec. 2, 2021

(54) BATTERY SYSTEMS AND METHODS FOR A MOBILE ROBOT

(71) Applicant: ROAM ROBOTICS INC., San Francisco, CA (US)

(72) Inventors: Austin Campbell, San Francisco, CA (US); Ashley Swartz, Daly City, CA (US); Jose Ochoa, Newark, CA (US); Kevin Conrad Kemper, San Francisco, CA (US); Timothy Alan Swift, Walnut Creek, CA (US)

(21) Appl. No.: 17/331,961

(22) Filed: May 27, 2021

Related U.S. Application Data
(60) Provisional application No. 63/030,586, filed on May 27, 2020.
(60) Provisional application No. 63/058,825, filed on Jul. 30, 2020.
(60) Provisional application No. 63/133,689, filed on Jan. 4, 2021.

(51) Int. Cl. A61H 3/00; A61H 1/02; B25J 9/00; B25J 19/00; B60L 53/80

(52) U.S. Cl. CPC A61H 3/00; A61H 1/024; B25J 9/0006; B25J 19/005; B60L 53/80; A61H 2003/007; B60L 2200/24; A61H 2201/1409; A61H 2201/5007; A61H 2201/0107; A61H 2201/5002; A61H 2201/1642; A61H 2201/1238

(57) ABSTRACT

An exoskeleton system comprising: a power system that powers the exoskeleton system, the power system including one or more battery slots, and a modular battery set that includes one or more battery units that are modular such that any of the one or more battery units can be readily and quickly removed and coupled within any of the one or more battery slots to provide power to the exoskeleton system.

### CROSS-REFERENCE TO RELATED APPLICATIONS

This application is a non-provisional of and claims priority to U.S. Provisional Patent Application No. 63/030,586, filed May 27, 2020, entitled “POWERED DEVICE FOR IMPROVED USER MOBILITY AND MEDICAL TREATMENT,” with attorney docket number 0110496-010PRO. This application is hereby incorporated herein by reference in its entirety and for all purposes.

This application is a non-provisional of and claims priority to U.S. Provisional Patent Application No. 63/058,825, filed Jul. 30, 2020, entitled “POWERED DEVICE TO BENEFIT A WEARER DURING TACTICAL APPLICATIONS,” with attorney docket number 0110496-011PRO. This application is hereby incorporated herein by reference in its entirety and for all purposes.

This application is a non-provisional of and claims priority to U.S. Provisional Patent Application No. 63/133,689, filed Jan. 4, 2021, entitled “BATTERY MANAGEMENT SYSTEM FOR A WEARABLE ROBOT,” with attorney docket number 0110496-013PRO. This application is hereby incorporated herein by reference in its entirety and for all purposes.

This application is also related to U.S. Non-Provisional applications filed the same day as this application having attorney docket numbers 0110496-010US0, 0110496-012US0, 0110496-014US0, 0110496-015US0, 0110496-016US0 and 0110496-017US0 respectively entitled “POWERED MEDICAL DEVICE AND METHODS FOR IMPROVED USER MOBILITY AND TREATMENT”, “FIT AND SUSPENSION SYSTEMS AND METHODS FOR A MOBILE ROBOT”, “CONTROL SYSTEM AND METHOD FOR A MOBILE ROBOT”, “USER INTERFACE AND FEEDBACK SYSTEMS AND METHODS FOR A MOBILE ROBOT”, “DATA LOGGING AND THIRD-PARTY ADMINISTRATION OF A MOBILE ROBOT” and “MODULAR EXOSKELETON SYSTEMS AND METHODS” and having respective application numbers XX/YYY,ZZZ, XX/YYY,ZZZ, XX/YYY,ZZZ, XX/YYY,ZZZ, XX/YYY,ZZZ and XX/YYY,ZZZ, These applications are hereby incorporated herein by reference in their entirety and for all purposes.

### BRIEF DESCRIPTION OF THE DRAWINGS

FIG. 1 is an example illustration of an embodiment of an exoskeleton system being worn by a user.

FIG. 2 is a front view of an embodiment of a leg actuation unit coupled to one leg of a user.

FIG. 3 is a side view of the leg actuation unit of FIG. 3 coupled to the leg of the user.

FIG. 4 is a perspective view of the leg actuation unit of FIGS. 3 and 4.

FIG. 5 is a block diagram illustrating an example embodiment of an exoskeleton system.

FIG. 6 illustrates one example embodiment of a power system and a modular battery set.

FIG. 7a illustrates a side view of a pneumatic actuator in a compressed configuration in accordance with one embodiment.

FIG. 7b illustrates a side view of the pneumatic actuator of FIG. 7a in an expanded configuration.

FIG. 8a illustrates a cross-sectional side view of a pneumatic actuator in a compressed configuration in accordance with another embodiment.

FIG. 8b illustrates a cross-sectional side view of the pneumatic actuator of FIG. 8a in an expanded configuration.

FIG. 9a illustrates a top view of a pneumatic actuator in a compressed configuration in accordance with another embodiment.

FIG. 9b illustrates a top view of the pneumatic actuator of FIG. 9a in an expanded configuration.

FIG. 10 illustrates a top view of a pneumatic actuator constraint rib in accordance with an embodiment.

FIG. 11a illustrates a cross-sectional view of a pneumatic actuator bellows in accordance with another embodiment.

FIG. 11b illustrates a side view of the pneumatic actuator of FIG. 11a in an expanded configuration showing the cross section of FIG. 11a.

FIG. 12 illustrates an example planar material that is substantially inextensible along one or more plane axes of the planar material while being flexible in other directions.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

This disclosure provides example embodiments of a novel power system and battery management system for mobile electronics and associated methods. This battery management system, in some examples, has a unique benefit in body worn applications, and even more specifically can have direct application to the development of worn robotics such as exoskeletons. Such systems and methods can present a specific benefit to a variety of application areas which include recreation, consumer, military, first responders, or health care. In each of these applications the need exists to have a sufficient amount of stored power to operate a system on board while balancing user desire to reduce weight as much as possible. This disclosure describes various embodiments of such a power system and battery management system and integration into various example systems.

This disclosure teaches methods for designing, integrating, and operating various embodiments of a power system and battery management system designed for mobile powered devices. One preferred embodiment is the integration of the power system and battery management system into a powered wearable robotic device that is designed to introduce mechanical power to one or more joints of a user. Such an embodiment can be of specific interest due to the magnitude of power that may be required to be introduced in some examples, which may otherwise be inconvenient to integrate all the battery capacity to complete all potential behaviors envisioned by a user. While some specific high-power embodiments will serve as the center of discussion in various examples herein, it should be made clear that this is for descriptive purposes only. There is accordingly no limitation to applying a power system or battery management system to other mobile powered devices.

The following disclosure also includes example embodiments of the design of novel exoskeleton devices. Various preferred embodiments include: a leg brace with integrated actuation, a mobile power source and a control unit that determines the output behavior of the device in real-time.

A component of an exoskeleton system that is present in various embodiments is a body-worn, lower-extremity brace that incorporates the ability to introduce torque to the user. One preferred embodiment of this component is a leg brace that is configured to support the knee of the user and includes actuation across the knee joint to provide assistance torques in the extension direction. This embodiment can connect to the user through a series of attachments including one on the boot, below the knee, and along the user's thigh. This preferred embodiment can include this type of leg brace on both legs of the user.

The present disclosure teaches example embodiments of a fluidic exoskeleton system that includes one or more adjustable fluidic actuators. Some preferred embodiments include a fluidic actuator that can be operated at various pressure levels with a large stroke length in a configuration that can be oriented with a joint on a human body.

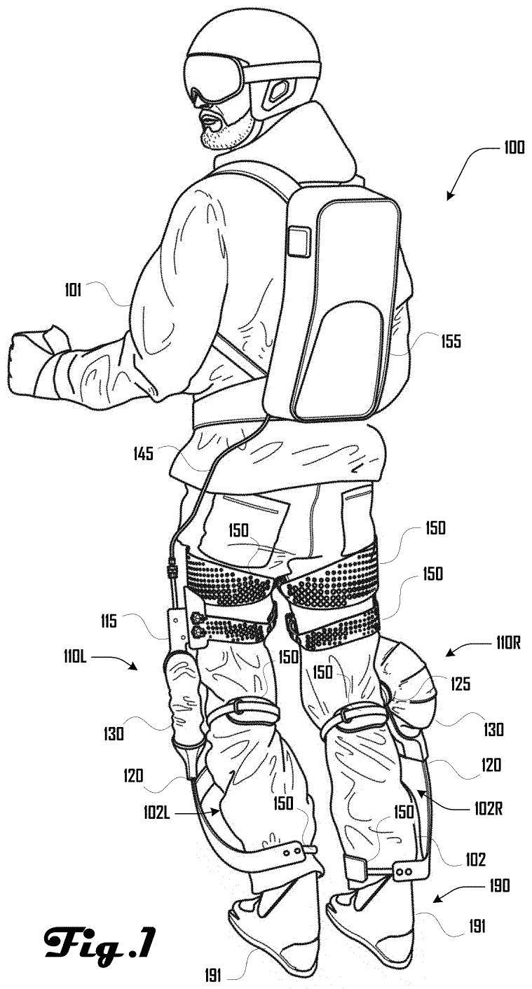

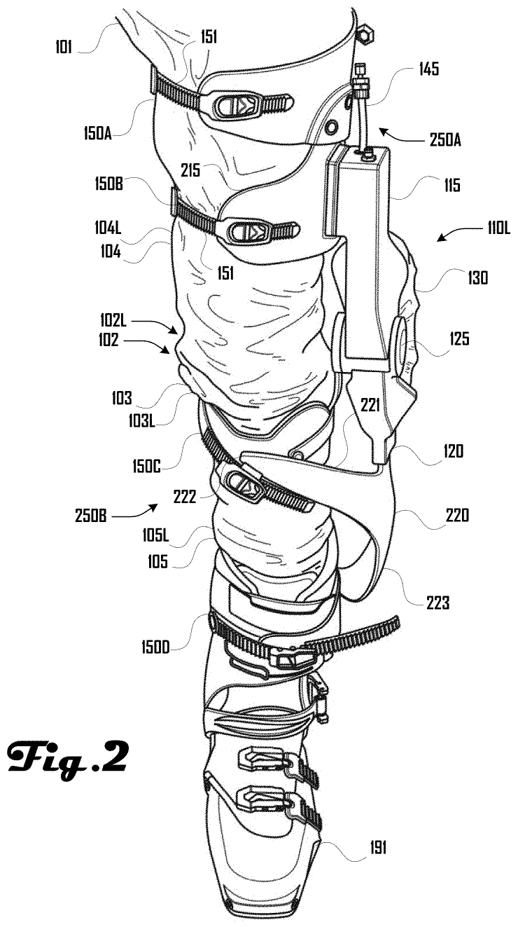

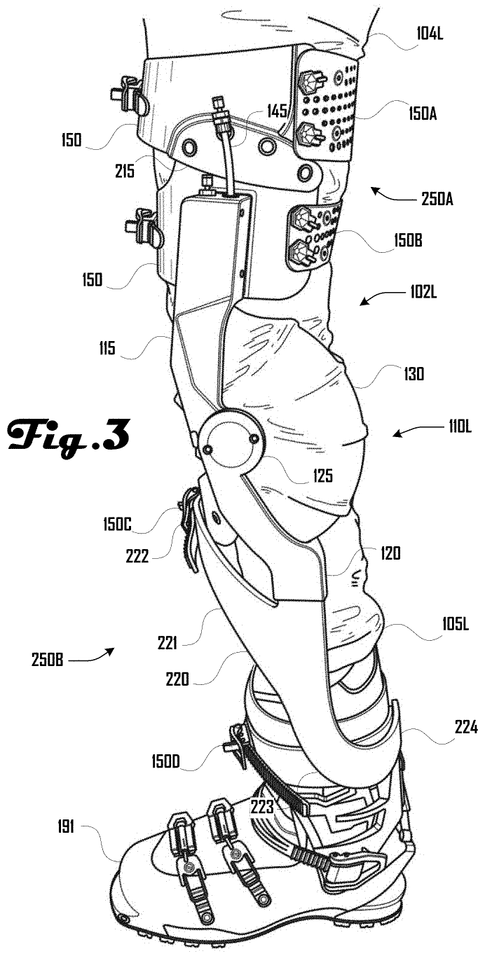

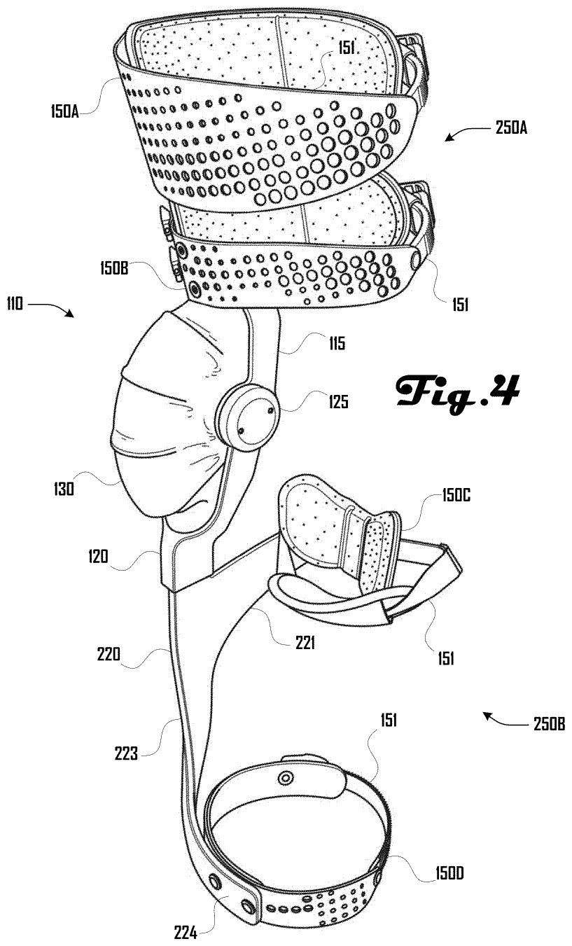

As discussed herein, an exoskeleton system 100 can be configured for various suitable uses. For example, FIGS. 1-3 illustrate an exoskeleton system 100 being used by a user. As shown in FIG. 1 the user 101 can wear the exoskeleton system 100 on both legs 102. FIGS. 2 and 3 illustrate a front and side view of an actuator unit 110 coupled to a leg 102 of a user 101 and FIG. 4 illustrates a side view of an actuator unit 110 not being worn by a user 101.

As shown in the example of FIG. 1, the exoskeleton system 100 can comprise a left and right leg actuator unit 110L, 110R that are respectively coupled to a left and right leg 102L, 102R of the user. In various embodiments, the left and right leg actuator units 110L, 110R can be substantially mirror images of each other.

As shown in FIGS. 1-4, leg actuator units 110 can include an upper arm 115 and a lower arm 120 that are rotatably coupled via a joint 125. A bellows actuator 130 extends between the upper arm 115 and lower arm 120. One or more sets of pneumatic lines 145 can be coupled to the bellows actuator 130 to introduce and/or remove fluid from the bellows actuator 130 to cause the bellows actuator 130 to expand and contract and to stiffen and soften, as discussed herein. A backpack 155 can be worn by the user 101 and can hold various components of the exoskeleton system 100 such as a fluid source, control system, a power source, and the like.

As shown in FIGS. 1-3, the leg actuator units 110L, 110R can be respectively coupled about the legs 102L, 102R of the user 101 with the joints 125 positioned at the knees 103L, 103R of the user 101 with the upper arms 115 of the leg actuator units 110L, 110R being coupled about the upper legs portions 104L, 104R of the user 101 via one or more couplers 150 (e.g., straps that surround the legs 102). The lower arms 120 of the leg actuator units 110L, 110R can be coupled about the lower leg portions 105L, 105R of the user 101 via one or more couplers 150.

The upper and lower arms 115, 120 of a leg actuator unit 110 can be coupled about the leg 102 of a user 101 in various suitable ways. For example, FIGS. 1-3 illustrates an example where the upper and lower arms 115, 120 and joint 125 of the leg actuator unit 110 are coupled along lateral faces (sides) of the top and bottom portions 104, 105 of the leg 102. As shown in the example of FIGS. 1-3, the upper arm 115 can be coupled to the upper leg portion 104 of a leg 102 above the knee 103 via two couplers 150 and the lower arm 120 can be coupled to the lower leg portion 105 of a leg 102 below the knee 103 via two couplers 150.

Specifically, upper arm 115 can be coupled to the upper leg portion 104 of the leg 102 above the knee 103 via a first set of couplers 250A that includes a first and second coupler 150A, 150B. The first and second couplers 150A, 150B can be joined by a rigid plate assembly 215 disposed on a lateral side of the upper leg portion 104 of the leg 102, with straps 151 of the first and second couplers 150A, 150B extending around the upper leg portion 104 of the leg 102. The upper arm 115 can be coupled to the plate assembly 215 on a lateral side of the upper leg portion 104 of the leg 102, which can transfer force generated by the upper arm 115 to the upper leg portion 104 of the leg 102.

The lower arm 120 can be coupled to the lower leg portion 105 of a leg 102 below the knee 103 via second set of couplers 250B that includes a third and fourth coupler 150C, 150D. A coupling branch unit 220 can extend from a distal end of, or be defined by a distal end of the lower arm 120. The coupling branch unit 220 can comprise a first branch 221 that extends from a lateral position on the lower leg portion 105 of the leg 102, curving upward and toward the anterior (front) of the lower leg portion 105 to a first attachment 222 on the anterior of the lower leg portion 105 below the knee 103, with the first attachment 222 joining the third coupler 150C and the first branch 221 of the coupling branch unit 220. The coupling branch unit 220 can comprise a second branch 223 that extends from a lateral position on the lower leg portion 105 of the leg 102, curving downward and toward the posterior (back) of the lower leg portion 105 to a second attachment 224 on the posterior of the lower leg portion 105 below the knee 103, with the second attachment 224 joining the fourth coupler 150D and the second branch 223 of the coupling branch unit 220.

As shown in the example of FIGS. 1-3, the fourth coupler 150D can be configured to surround and engage the boot 191 of a user. For example, the strap 151 of the fourth coupler 150D can be of a size that allows the fourth coupler 150D to surround the larger diameter of a boot 191 compared to the lower portion 105 of the leg 102 alone. Also, the length of the lower arm 120 and/or coupling branch unit 220 can be of a length sufficient for the fourth coupler 150D to be positioned over a boot 191 instead of being of a shorter length such that the fourth coupler 150D would surround a section of the lower portion 105 of the leg 102 above the boot 191 when the leg actuator unit 110 is worn by a user.

Attaching to the boot 191 can vary across various embodiments. In one embodiment, this attachment can be accomplished through a flexible strap that wraps around the circumference of boot 191 to affix the leg actuator unit 110 to the boot 191 with the desired amount of relative motion between the leg actuator unit 110 and the strap. Other embodiments can work to restrict various degrees of freedom while allowing the desired amount of relative motion between the leg actuator unit 110 and the boot 191 in other degrees of freedom. One such embodiment can include the use of a mechanical clip that connects to the back of the boot 191 that can provide a specific mechanical connection between the device and the boot 191. Various embodiments can include but are not limited to the designs listed previously, a mechanical bolted connection, a rigid strap, a magnetic connection, an electro-magnetic connection, an electromechanical connection, an insert into the user's boot, a rigid or flexible cable, or a connection directly to a 192.

Another aspect of the exoskeleton system 100 can be fit components used to secure the exoskeleton system 100 to the user 101. Since the function of the exoskeleton system 100 in various embodiments can rely heavily on the fit of the exoskeleton system 100 efficiently transmitting forces between the user 101 and the exoskeleton system 100 without the exoskeleton system 100 significantly drifting on the body 101 or creating discomfort, improving the fit of the exoskeleton system 100 and monitoring the fit of the exoskeleton system 100 to the user over time can be desirable for the overall function of the exoskeleton system 100 in some embodiments.

In various examples, different couplers 150 can be configured for different purposes, with some couplers 150 being primarily for the transmission of forces, with others being configured for secure attachment of the exoskeleton system 100 to the body 101. In one preferred embodiment for a single knee system, a coupler 150 that sits on the lower leg 105 of the user 101 (e.g., one or both of couplers 150C, 150D) can be intended to target body fit, and as a result, can remain flexible and compliant to conform to the body of the user 101. Alternatively, in this embodiment a coupler 150 that affixes to the front of the user's thigh on an upper portion 104 of the leg 102 (e.g., one or both of couplers 150A, 150B) can be intended to target power transmission needs and can have a stiffer attachment to the body than other couplers 150 (e.g., one or both of couplers 150C, 150D). Various embodiments can employ a variety of strapping or coupling configurations, and these embodiments can extend to include any variety of suitable straps, couplings, or the like, where two parallel sets of coupling configurations are meant to fill these different needs.

In some cases the design of the joint 125 can improve the fit of the exoskeleton system 100 on the user. In one embodiment, the joint 125 of a single knee leg actuator unit 110 can be designed to use a single pivot joint that has some deviations with the physiology of the knee joint. Another embodiment, uses a polycentric knee joint to better fit the motion of the human knee joint, which in some examples can be desirably paired with a very well fit leg actuator unit 110. Various embodiments of a joint 125 can include but are not limited to the example elements listed above, a ball and socket joint, a four bar linkage, and the like.

Some embodiments can include fit adjustments for anatomical variations in varus or valgus angles in the lower leg 105. One preferred embodiment includes an adjustment incorporated into a leg actuator unit 110 in the form of a cross strap that spans the joint of the knee 103 of the user 101, which can be tightened to provide a moment across the knee joint in the frontal plane which varies the nominal resting angle. Various embodiments can include but are not limited to the following: a strap that spans the joint 125 to vary the operating angle of the joint 125; a mechanical assembly including a screw that can be adjusted to vary the angle of the joint 125; mechanical inserts that can be added to the leg actuator unit 110 to discreetly change the default angle of the joint 125 for the user 101, and the like.

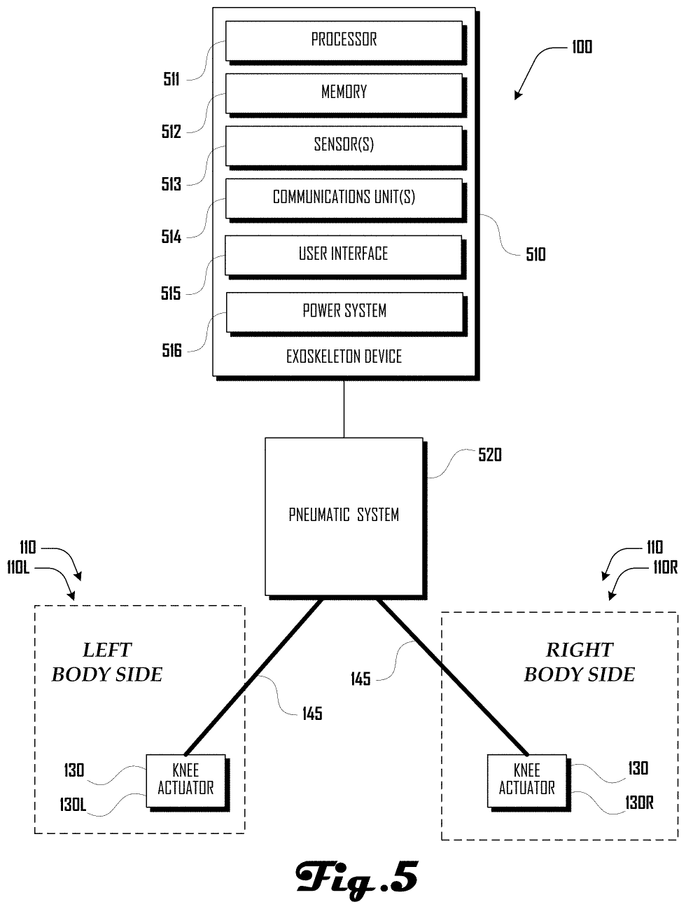

In various embodiments, the leg actuator unit 110 can be configured to remain suspended vertically on the leg 102 and remain appropriately positioned with the joint of the knee 103. In one embodiment, coupler 150 associated with a boot 191 (e.g., coupler 150D) can provide a vertical retention force for a leg actuator unit 110. Another embodiment uses a coupler 150 positioned on the lower leg 105 of the user 101 (e.g., one or both of couplers 150C, 150D) that exerts a vertical force on the leg actuator unit 110 by reacting on the calf of the user 101. Various embodiments can include but are not limited to the following: suspension forces transmitted through a coupler 150 on the boot (e.g., coupler 150D) or another embodiment of the boot attachment discussed previously; suspension forces transmitted through an electronic and/or fluidic cable assembly; suspension forces transmitted through a connection to a waist belt; suspension forces transmitted through a mechanical connection to a backpack 155 or other housing for the exoskeleton device 510 and/or pneumatic system 520 (see FIG. 5); suspension forces transmitted through straps or a harness to the shoulders of the user 101, and the like.

In various embodiments, a leg actuator unit 110 can be spaced apart from the leg 102 of the user with a limited number of attachments to the leg 102. For example, in some embodiments, the leg actuator unit 110 can consist or consist essentially of three attachments to the leg 102 of the user 101, namely via the first and second attachments 222, 224 and 215. In various embodiments, the couplings of the leg actuator unit 110 to the lower leg portion 105 can consist or consist essentially of a first and second attachment on the anterior and posterior of the lower leg portion 105. In various embodiments, the coupling of the leg actuator unit 110 to the upper leg portion 104 can consist or consist essentially of a single lateral coupling, which can be associated with one or more couplers 150 (e.g., two couplers 150A, 150B as shown in FIGS. 1-4). In various embodiments, such a configuration can be desirable based on the specific force-transfer for use during a subject activity. Accordingly, the number and positions of attachments or coupling to the leg 102 of the user 101 in various embodiments is not a simple design choice and can be specifically selected for one or more selected target user activities.

While specific embodiments of couplers 150 are illustrated herein, in further embodiments, such components discussed herein can be operably replaced by an alternative structure to produce the same functionality. For example, while straps, buckles, padding and the like are shown in various examples, further embodiments can include couplers 150 of various suitable types and with various suitable elements. For example, some embodiments can include Velcro hook-and-loop straps, or the like.

FIGS. 1-3 illustrate an example of an exoskeleton system 100 where the joint 125 is disposed laterally and adjacent to the knee 103 with a rotational axis of the joint 125 being disposed parallel to a rotational axis of the knee 103. In some embodiments, the rotational axis of the joint 125 can be coincident with the rotational axis of the knee 103. In some embodiments, a joint can be disposed on the anterior of the knee 103, posterior of the knee 103, inside of the knee 103, or the like.

In various embodiments, the joint structure 125 can constrain the bellows actuator 130 such that force created by actuator fluid pressure within the bellows actuator 130 can be directed about an instantaneous center (which may or may not be fixed in space). In some cases of a revolute or rotary joint, or a body sliding on a curved surface, this instantaneous center can coincide with the instantaneous center of rotation of the joint 125 or a curved surface. Forces created by a leg actuator unit 110 about a rotary joint 125 can be used to apply a moment about an instantaneous center as well as still be used to apply a directed force. In some cases of a prismatic or linear joint (e.g., a slide on a rail, or the like), the instantaneous center can be kinematically considered to be located at infinity, in which case the force directed about this infinite instantaneous center can be considered as a force directed along the axis of motion of the prismatic joint. In various embodiments, it can be sufficient for a rotary joint 125 to be constructed from a mechanical pivot mechanism. In such an embodiment, the joint 125 can have a fixed center of rotation that can be easy to define, and the bellows actuator 130 can move relative to the joint 125. In a further embodiment, it can be beneficial for the joint 125 to comprise a complex linkage that does not have a single fixed center of rotation. In yet another embodiment, the joint 125 can comprise a flexure design that does not have a fixed joint pivot. In still further embodiments, the joint 125 can comprise a structure, such as a human joint, robotic joint, or the like.

In various embodiments, leg actuator unit 110 (e.g., comprising bellows actuator 130, joint structure 125, and the like) can be integrated into a system to use the generated directed force of the leg actuator unit 110 to accomplish various tasks. In some examples, a leg actuator unit 110 can have one or more unique benefits when the leg actuator unit 110 is configured to assist the human body or is included into a powered exoskeleton system 100. In an example embodiment, the leg actuator unit 110 can be configured to assist the motion of a human user about the user's knee joint 103. To do so, in some examples, the instantaneous center of the leg actuator unit 110 can be designed to coincide or nearly coincide with the instantaneous center of rotation of the knee 103 of a user 101. In one example configuration, the leg actuator unit 110 can be positioned lateral to the knee joint 103 as shown in FIGS. 1-3. In various examples, the human knee joint 103 can function as (e.g., in addition to or in place of) the joint 125 of the leg actuator unit 110.

For clarity, example embodiments discussed herein should not be viewed as a limitation of the potential applications of the leg actuator unit 110 described within this disclosure. The leg actuator unit 110 can be used on other joints of the body including but not limited to one or more elbow, one or more hip, one or more finger, one or more ankle, spine, or neck. In some embodiments, the leg actuator unit 110 can be used in applications that are not on the human body such as in robotics, for general purpose actuation, animal exoskeletons, or the like.

Also, embodiments can be used for or adapted for various suitable applications such as tactical, medical, or labor applications, and the like. Examples of such applications can be found in U.S. patent application Ser. No. 15/823,523, filed Nov. 27, 2017 entitled “PNEUMATIC EXOMUSCLE SYSTEM AND METHOD” with attorney docket number 0110496-002US1 and U.S. patent application Ser. No. 15/953,296, filed Apr. 13, 2018 entitled “LEG EXOSKELETON SYSTEM AND METHOD” with attorney docket number 0110496-004US0, which are incorporated herein by reference.

Some embodiments can apply a configuration of a leg actuator unit 110 as described herein for linear actuation applications. In an example embodiment, the bellows actuator 130 can comprise a two-layer impermeable/inextensible construction, and one end of one or more constraining ribs can be fixed to the bellows actuator 130 at predetermined positions. The joint structure 125 in various embodiments can be configured as a series of slides on a pair of linear guide rails, where the remaining end of one or more constraining ribs is connected to a slide. The motion and force of the fluidic actuator can therefore be constrained and directed along the linear rail.

FIG. 5 is a block diagram of an example embodiment of an exoskeleton system 100 that includes an exoskeleton device 510 that is operably connected to a pneumatic system 520. While a pneumatic system 520 is used in the example of FIG. 5, further embodiments can include any suitable fluidic system or a pneumatic system 520 can be absent in some embodiments, such as where an exoskeleton system 100 is actuated by electric motors, or the like.

The exoskeleton device 510 in this example comprises a processor 511, a memory 512, one or more sensors 513 a communication unit 514, a user interface 515 and a power source 516. A plurality of actuators 130 are operably coupled to the pneumatic system 520 via respective pneumatic lines 145. The plurality of actuators 130 include a pair of knee-actuators 130L and 130R that are positioned on the right and left side of a body 100. For example, as discussed above, the example exoskeleton system 100 shown in FIG. 5 can comprise a left and right leg actuator unit 110L, 110R on respective sides of the body 101 as shown in FIGS. 1 and 2 with one or both of the exoskeleton device 510 and pneumatic system 520, or one or more components thereof, stored within or about a backpack 155 (see FIG. 1) or otherwise mounted, worn or held by a user 101.

Accordingly, in various embodiments, the exoskeleton system 100 can be a completely mobile and self-contained system that is configured to be powered and operate for an extended period of time without an external power source during various user activities. The size, weight and configuration of the actuator unit(s) 110, exoskeleton device 510 and pneumatic system 520 can therefore be configured in various embodiments for such mobile and self-contained operation.

In various embodiments, the example system 100 can be configured to move and/or enhance movement of the user 101 wearing the exoskeleton system 100. For example, the exoskeleton device 510 can provide instructions to the pneumatic system 520, which can selectively inflate and/or deflate the bellows actuators 130 via pneumatic lines 145. Such selective inflation and/or deflation of the bellows actuators 130 can move and/or support one or both legs 102 to generate and/or augment body motions such as walking, running, jumping, climbing, lifting, throwing, squatting, skiing or the like.

In some cases, the exoskeleton system 100 can be designed to support multiple configurations in a modular configuration. For example, one embodiment is a modular configuration that is designed to operate in either a single knee configuration or in a double knee configuration as a function of how many of the actuator units 110 are donned by the user 101. For example, the exoskeleton device 510 can determine how many actuator units 110 are coupled to the pneumatic system 520 and/or exoskeleton device 510 (e.g., on or two actuator units 110) and the exoskeleton device 510 can change operating capabilities based on the number of actuator units 110 detected.

In further embodiments, the pneumatic system 520 can be manually controlled, configured to apply a constant pressure, or operated in any other suitable manner. In some embodiments, such movements can be controlled and/or programmed by the user 101 that is wearing the exoskeleton system 100 or by another person. In some embodiments, the exoskeleton system 100 can be controlled by movement of the user 101. For example, the exoskeleton device 510 can sense that the user is walking and carrying a load and can provide a powered assist to the user via the actuators 130 to reduce the exertion associated with the load and walking. Similarly, where a user 101 wears the exoskeleton system 100, the exoskeleton system 100 can sense movements of the user 101 and can provide a powered assist to the user via the actuators 130 to enhance or provide an assist to the user while skiing.

Accordingly, in various embodiments, the exoskeleton system 130 can react automatically without direct user interaction. In further embodiments, movements can be controlled in real-time by user interface 515 such as a controller, joystick, voice control or thought control. Additionally, some movements can be pre-preprogrammed and selectively triggered (e.g., walk forward, sit, crouch) instead of being completely controlled. In some embodiments, movements can be controlled by generalized instructions (e.g. walk from point A to point B, pick up box from shelf A and move to shelf B).

The user interface 515 can allow the user 101 to control various aspects of the exoskeleton system 100 including powering the exoskeleton system 100 on and off; controlling movements of the exoskeleton system 100; configuring settings of the exoskeleton system 100, and the like. The user interface 515 can include various suitable input elements such as a touch screen, one or more buttons, audio input, and the like. The user interface 515 can be located in various suitable locations about the exoskeleton system 100. For example, in one embodiment, the user interface 515 can be disposed on a strap of a backpack 155, or the like. In some embodiments, the user interface can be defined by a user device such as smartphone, smart-watch, wearable device, or the like.

In various embodiments, the power source 516 can be a mobile power source that provides the operational power for the exoskeleton system 100. In one preferred embodiment, the power pack unit contains some or all of the pneumatic system 520 (e.g., a compressor) and/or power source (e.g., batteries) required for the continued operation of pneumatic actuation of the leg actuator units 110. The contents of such a power pack unit can be correlated to the specific actuation approach configured to be used in the specific embodiment. In some embodiments, the power pack unit will only contain batteries which can be the case in an electromechanically actuated system or a system where the pneumatic system 520 and power source 516 are separate. Various embodiments of a power pack unit can include but are not limited to a combination of the one or more of the following items: pneumatic compressor, batteries, stored high-pressure pneumatic chamber, hydraulic pump, pneumatic safety components, electric motor, electric motor drivers, microprocessor, and the like. Accordingly, various embodiments of a power pack unit can include one or more of elements of the exoskeleton device 510 and/or pneumatic system 520.

Such components can be configured on the body of a user 101 in a variety of suitable ways. One preferred embodiment is the inclusion of a power pack unit in a torso-worn pack that is not operably coupled to the leg actuator units 110 in any manner that transmits substantial mechanical forces to the leg actuator units 110. Another embodiment includes the integration of the power pack unit, or components thereof, into the leg actuator units 110 themselves. Various embodiments can include but are not limited to the following configurations: torso-mounted in a backpack, torso-mounted in a messenger bag, hip-mounted bag, mounted to the leg, integrated into the brace component, and the like. Further embodiments can separate the components of the power pack unit and disperse them into various configurations on the user 101. Such an embodiment may configure a pneumatic compressor on the torso of the user 101 and then integrate the batteries into the leg actuator units 110 of the exoskeleton system 100.

One aspect of the power supply 516 in various embodiments is that it must be connected to the brace component in such a manner as to pass the operable system power to the brace for operation. One preferred embodiment is the use of electrical cables to connect the power supply 516 and the leg actuator units 110. Other embodiments can use electrical cables and a pneumatic line 145 to deliver electrical power and pneumatic power to the leg actuator units 110. Various embodiments can include but are not limited to any configuration of the following connections: pneumatic hosing, hydraulic hosing, electrical cables, wireless communication, wireless power transfer, and the like.

In some embodiments, it can be desirable to include secondary features that extend the capabilities of a cable connection (e.g., pneumatic lines 145 and/or power lines) between the leg actuator units 110 and the power supply 516 and/or pneumatic system 520. One preferred embodiment includes retractable cables that are configured to have a small mechanical retention force to maintain cables that are pulled tight against the user with reduced slack remaining in the cable. Various embodiments can include, but are not limited to a combination of the following secondary features: retractable cables, a single cable including both fluidic and electrical power, magnetically-connected electrical cables, mechanical quick releases, breakaway connections designed to release at a specified pull force, integration into mechanical retention features on the user's clothing, and the like. Yet another embodiment can include routing the cables in such a way as to minimize geometric differences between the user 101 and the cable lengths. One such embodiment in a dual knee configuration with a torso power supply can be routing the cables along the user's lower torso to connect the right side of a power supply bag with the left knee of the user. Such a routing can allow the geometric differences in length throughout the user's normal range of motion.

One specific additional feature that can be a concern in some embodiments is the need for proper heat management of the exoskeleton system 100. As a result, there are a variety of features that can be integrated specifically for the benefit of controlling heat. One preferred embodiment integrates exposed heat sinks to the environment that allow elements of the exoskeleton device 510 and/or pneumatic system 520 to dispel heat directly to the environment through unforced cooling using ambient airflow. Another embodiment directs the ambient air through internal air channels in a backpack 155 or other housing to allow for internal cooling. Yet another embodiment can extend upon this capability by introducing scoops on a backpack 155 or other housing in an effort to allow air flow through the internal channels. Various embodiments can include but are not limited to the following: exposed heat sinks that are directly connected to a high heat component; a water-cooled or fluid-cooled heat management system; forced air cooling through the introduction of a powered fan or blower; external shielded heat sinks to protect them from direct contact by a user, and the like.

In some cases, it may be beneficial to integrate additional features into the structure of the backpack 155 or other housing to provide additional features to the exoskeleton system 100. One preferred embodiment is the integration of mechanical attachments to support storage of the leg actuator units 110 along with the exoskeleton device 510 and/or pneumatic system 520 in a small package. Such an embodiment can include a deployable pouch that can secure the leg actuator units 110 against the backpack 155 along with mechanical clasps that hold the upper or lower arms 115, 120 of the actuator units 110 to the backpack 155. Another embodiment is the inclusion of storage capacity into the backpack 155 so the user 101 can hold additional items such as a water bottle, food, personal electronics, and other personal items. Various embodiments can include but are not limited to other additional features such as the following: a warming pocket which is heated by hot airflow from the exoskeleton device 510 and/or pneumatic system 520; air scoops to encourage additional airflow internal to the backpack 155; strapping to provide a closer fit of the backpack 155 on the user, waterproof storage, temperature-regulated storage, and the like.

In a modular configuration, it may be required in some embodiments that the exoskeleton device 510 and/or pneumatic system 520 can be configured to support the power, fluidic, sensing and control requirements and capabilities of various potential configurations of the exoskeleton system. One preferred embodiment can include an exoskeleton device 510 and/or pneumatic system 520 that can be tasked with powering a dual knee configuration or a single knee configuration (i.e., with one or two leg actuator units 110 on the user 101). Such an exoskeleton system 100 can support the requirements of both configurations and then appropriately configure power, fluidic, sensing and control based on a determination or indication of a desired operating configuration. Various embodiments exist to support an array of potential modular system configurations, such as multiple batteries, and the like.

In various embodiments, the exoskeleton device 100 can be operable to perform methods or portions of methods described in more detail below or in related applications incorporated herein by reference. For example, the memory 512 can include non-transitory computer readable instructions (e.g., software), which if executed by the processor 511, can cause the exoskeleton system 100 to perform methods or portions of methods described herein or in related applications incorporated herein by reference.

This software can embody various methods that interpret signals from the sensors 513 or other sources to determine how to best operate the exoskeleton system 100 to provide the desired benefit to the user. The specific embodiments described below should not be used to imply a limit on the sensors 513 that can be applied to such an exoskeleton system 100 or the source of sensor data. While some example embodiments can require specific information to guide decisions, it does not create an explicit set of sensors 513 that an exoskeleton system 100 will require and further embodiments can include various suitable sets of sensors 513. Additionally, sensors 513 can be located at various suitable locations on an exoskeleton system 100 including as part of an exoskeleton device 510, pneumatic system 520, one or more fluidic actuator 130, or the like. Accordingly, the example illustration of FIG. 5 should not be construed to imply that sensors 513 are exclusively disposed at or part of an exoskeleton device 510 and such an illustration is merely provided for purposes of simplicity and clarity.

One aspect of control software can be the operational control of leg actuator units 110, exoskeleton device 510 and pneumatic system 520 to provide the desired response. There can be various suitable responsibilities of the operational control software. For example, as discussed in more detail below, one can be low-level control which can be responsible for developing baseline feedback for operation of the leg actuator units 110, exoskeleton device 510 and pneumatic system 520. Another can be intent recognition which can be responsible for identifying the intended maneuvers of the user 101 based on data from the sensors 513 and causing the exoskeleton system 100 to operate based on one or more identified intended maneuvers. A further example can include reference generation, which can include selecting the desired torques the exoskeleton system 100 should generate to best assist the user 101. It should be noted that this example architecture for delineating the responsibilities of the operational control software is merely for descriptive purposes and in no way limits the wide variety of software approaches that can be deployed on further embodiments of an exoskeleton system 100.

One method implemented by control software can be for the low-level control and communication of the exoskeleton system 100. This can be accomplished via a variety of methods as required by the specific joint and need of the user. In a preferred embodiment, the operational control is configured to provide a desired torque by the leg actuator unit 110 at the user's joint. In such a case, the exoskeleton system 100 can create low-level feedback to achieve a desired joint torque by the leg actuator units 110 as a function of feedback from the sensors 513 of the exoskeleton system 100. For example, such a method can include obtaining sensor data from one or more sensors 513, determining whether a change in torque by the leg actuator unit 110 is necessary, and if so, causing the pneumatic system 520 to change the fluid state of the leg actuator unit 110 to achieve a target joint torque by the leg actuator unit 110. Various embodiments can include, but are not limited to, the following: current feedback; recorded behavior playback; position-based feedback; velocity-based feedback; feedforward responses; volume feedback which controls a fluidic system 520 to inject a desired volume of fluid into an actuator 130, and the like.

Another method implemented by operational control software can be for intent recognition of the user's intended behaviors. This portion of the operational control software, in some embodiments, can indicate any array of allowable behaviors that the system 100 is configured to account for. In one preferred embodiment, the operational control software is configured to identify two specific states: Walking, and Not Walking. In such an embodiment, to complete intent recognition, the exoskeleton system 100 can use user input and/or sensor readings to identify when it is safe, desirable or appropriate to provide assistive actions for walking. For example, in some embodiments, intent recognition can be based on input received via the user interface 515, which can include an input for Walking, and Not Walking. Accordingly, in some examples, the use interface can be configured for a binary input consisting of Walking, and Not Walking.

In some embodiments, a method of intent recognition can include the exoskeleton device 510 obtaining data from the sensors 513 and determining, based at least in part of the obtained data, whether the data corresponds to a user state of Walking, and Not Walking. Where a change in state has been identified, the exoskeleton system 100 can be re-configured to operate in the current state. For example, the exoskeleton device 510 can determine that the user 101 is in a Not Walking state such as sitting and can configure the exoskeleton system 100 to operate in a Not Walking configuration. For example, such a Not Walking configuration can, compared to a Walking configuration, provide for a wider range of motion; provide no torque or minimal torque to the leg actuation units 110; save power and fluid by minimizing processing and fluidic operations; cause the system to be alert for supporting a wider variety of non-skiing motion, and the like.

The exoskeleton device 510 can monitor the activity of the user 101 and can determine that the user is walking or is about to walk (e.g., based on sensor data and/or user input), and can then configure the exoskeleton system 100 to operate in a Walking configuration. For example, such a Walking configuration, compared to a Not Walking configuration, can allow for a more limited range of motion that would be present during skiing (as opposed to motions during non-walking); provide for high or maximum performance by increasing the processing and fluidic response of the exoskeleton system 100 to support skiing; and the like. When the user 101 finishes a walking session, is identified as resting, or the like, the exoskeleton system 100 can determine that the user is no longer walking (e.g., based on sensor data and/or user input) and can then configure the exoskeleton system 100 to operate in the Not Walking configuration.

In some embodiments, there can be a plurality of Walking states, or Walking sub-states that can be determined by the exoskeleton system 100, including hard walking, moderate walking, light walking, downhill, uphill, jumping, recreational, sport, running, and the like (e.g., based on sensor data and/or user input). Such states can be based on the difficulty of the walking, ability of the user, terrain, weather conditions, elevation, angle of the walking surface, desired performance level, power-saving, and the like. Accordingly, in various embodiments, the exoskeleton system 100 can adapt for various specific types of walking or movement based on a wide variety of factors.

Another method implemented by operational control software can be the development of desired referenced behaviors for the specific joints providing assistance. This portion of the control software can tie together identified maneuvers with the level control. For example, when the exoskeleton system 100 identifies an intended user maneuver, the software can generate reference behaviors that define the torques, or positions desired by the actuators 130 in the leg actuation units 110. In one embodiment, the operational control software generates references to make the leg actuation units 110 simulate a mechanical spring at the knee 103 via the configuration actuator 130. The operational control software can generate torque references at the knee joints that are a linear function of the knee joint angle. In another embodiment, the operational control software generates a volume reference to provide a constant standard volume of air into a pneumatic actuator 130. This can allow the pneumatic actuator 130 to operate like a mechanical spring by maintaining the constant volume of air in the actuator 130 regardless of the knee angle, which can be identified through feedback from one or more sensors 513.

In another embodiment, a method implemented by the operational control software can include evaluating the balance of the user 101 while walking, moving, standing, or running and directing torque in such a way to encourage the user 101 to remain balanced by directing knee assistance to the leg 102 that is on the outside of the user's current balance profile. Accordingly, a method of operating an exoskeleton system 100 can include the exoskeleton device 510 obtaining sensor data from the sensors 510 indicating a balance profile of a user 101 based on the configuration of left and right leg actuation units 110L, 110R and/or environmental sensors such as position sensors, accelerometers, and the like. The method can further include determining a balance profile based on the obtained data, including an outside and inside leg, and then increasing torque to the actuation unit 110 associated with the leg 102 identified as the outside leg.

Various embodiments can use but are not limited to kinematic estimates of posture, joint kinetic profile estimates, as well as observed estimates of body pose. Various other embodiments exist for methods of coordinating two legs 102 to generate torques including but not limited to guiding torque to the most bent leg; guiding torque based on the mean amount of knee angle across both legs; scaling the torque as a function of speed or acceleration; and the like. It should also be noted that yet another embodiment can include a combination of various individual reference generation methods in a variety of matters which include but are not limited to a linear combination, a maneuver specific combination, or a non-linear combination.

In another embodiment, an operational control method can blend two primary reference generation techniques: one reference focused on static assistance and one reference focused on leading the user 101 into their upcoming behavior. In some examples, the user 101 can select how much predictive assistance is desired while using the exoskeleton system 100. For example, by a user 101 indicating a large amount of predictive assistance, the exoskeleton system 100 can be configured to be very responsive and may be well configured for a skilled operator on a challenging terrain. The user 101 could also indicate a desire for a very low amount of predictive assistance, which can result in slower system performance, which may be better tailored towards a learning user or less challenging terrain.

Various embodiments can incorporate user intent in a variety of manners and the example embodiments presented above should not be interpreted as limiting in any way. For example, method of determining and operating an exoskeleton system 100 can include systems and method of U.S. patent application Ser. No. 15/887,866, filed Feb. 2, 2018 entitled “SYSTEM AND METHOD FOR USER INTENT RECOGNITION,” having attorney docket number 0110496-003US0, which is incorporated herein by reference. Also, various embodiments can use user intent in a variety of manners including as a continuous unit, or as a discrete setting with only a few indicated values.

At times it can be beneficial for operational control software to manipulate its control to account for a secondary or additional objective in order to maximize device performance or user experience. In one embodiment, the exoskeleton system 100 can provide an elevation-aware control over a central compressor or other components of a pneumatic system 520 to account for the changing density of air at different elevations. For example, operational control software can identify that the system is operating at a higher elevation based on data from sensors 513, or the like, and provide more current to the compressor in order to maintain electrical power consumed by the compressor. Accordingly, a method of operating a pneumatic exoskeleton system 100 can include obtaining data indicating air density where the pneumatic exoskeleton system 100 is operating (e.g., elevation data), determining optimal operating parameters of the pneumatic system 520 based on the obtained data, and configuring operation based on the determined optimal operating parameters. In further embodiments, operation of a pneumatic exoskeleton system 100 such as operating volumes can be tuned based on environmental temperature, which may affect air volumes.

In another embodiment, the exoskeleton system 100 can monitor the ambient audible noise levels and vary the control behavior of the exoskeleton system 100 to reduce the noise profile of the system. For example, when a user 101 is in a quiet public place or quietly enjoying a location alone or with others, noise associated with actuation of the leg actuation units 110 can be undesirable (e.g., noise of running a compressor or inflating or deflating actuators 130). Accordingly, in some embodiments, the sensors 513 can include a microphone that detects ambient noise levels and can configure the exoskeleton system 100 to operate in a quiet mode when ambient noise volume is below a certain threshold. Such a quiet mode can configure elements of a pneumatic system 520 or actuators 130 to operate more quietly, or can delay or reduce frequency of noise made by such elements.

In the case of a modular system, it can be desirable in various embodiments for operational control software to operate differently based on the number of leg actuation units 110 operational within the exoskeleton system 100. For example, in some embodiments, a modular dual-knee exoskeleton system 100 (see e.g., FIGS. 1 and 2) can also operate in a single knee configuration where only one of two leg actuation units 110 are being worn by a user 101 (see e.g., FIGS. 3 and 4) and the exoskeleton system 100 can generate references differently when in a two-leg configuration compared to a single leg configuration. Such an embodiment can use a coordinated control approach to generate references where the exoskeleton system 100 is using inputs from both leg actuation units 110 to determine the desired operation. However in a single-leg configuration, the available sensor information may have changed, so in various embodiments the exoskeleton system 100 can implement a different control method. In various embodiments this can be done to maximize the performance of the exoskeleton system 100 for the given configuration or account for differences in available sensor information based on there being one or two leg actuation units 110 operating in the exoskeleton system 100.

Accordingly, a method of operating an exoskeleton system 100 can include a startup sequence where a determination is made by the exoskeleton device 510 whether one or two leg actuation units 110 are operating in the exoskeleton system 100; determining a control method based on the number of actuation units 110 that are operating in the exoskeleton system 100; and implementing and operating the exoskeleton system 100 with the selected control method. A further method operating an exoskeleton system 100 can include monitoring by the exoskeleton device 510 of actuation units 110 that are operating in the exoskeleton system 100, determining a change in the number of actuation units 110 operating in the exoskeleton system 100, and then determining and changing the control method based on the new number of actuation units 110 that are operating in the exoskeleton system 100.

For example, the exoskeleton system 100 can be operating with two actuation units 110 and with a first control method. The user 101 can disengage one of the actuation units 110, and the exoskeleton device 510 can identify the loss of one of the actuation units 110 and the exoskeleton device 510 can determine and implement a new second control method to accommodate loss of one of the actuation units 110. In some examples, adapting to the number of active actuation units 110 can be beneficial where one of the actuation units 110 is damaged or disconnected during use and the exoskeleton system 100 is able to adapt automatically so the user 101 can still continue working or moving uninterrupted despite the exoskeleton system 100 only having a single active actuation unit 110.

In various embodiments, operational control software can adapt a control method where user needs are different between individual actuation units 110 or legs 102. In such an embodiment, it can be beneficial for the exoskeleton system 100 to change the torque references generated in each actuation unit 110 to tailor the experience for the user 101. One example is of a dual knee exoskeleton system 100 (see e.g., FIG. 1) where a user 101 has significant weakness issues in a single leg 102, but only minor weakness issues in the other leg 102. In this example, the exoskeleton system 100 can be configured to scale down the output torques on the less-affected limb compared to the more-affected limb to best meet the needs of the user 101.

Such a configuration based on differential limb strength can be done automatically by the exoskeleton system 100 and/or can be configured via a user interface 516, or the like. For example, in some embodiments, the user 101 can perform a calibration test while using the exoskeleton system 100, which can test relative strength or weakness in the legs 102 of the user 101 and configure the exoskeleton system 100 based on identified strength or weakness in the legs 102. Such a test can identify general strength or weakness of legs 102 or can identify strength or weakness of specific muscles or muscle groups such as the quadriceps, calves, hamstrings, gluteus, gastrocnemius; femoris, sartorius, soleus, and the like.

Another aspect of a method for operating an exoskeleton system 100 can include control software that monitors the exoskeleton system 100. A monitoring aspect of such software can, in some examples, focus on monitoring the state of the exoskeleton system 100 and the user 101 throughout normal operation in an effort to provide the exoskeleton system 100 with situational awareness and understanding of sensor information in order to drive user understanding and device performance. One aspect of such monitoring software can be to monitor the state of the exoskeleton system 100 in order to provide device understanding to achieve a desired performance capability. A portion of this can be the development of a system body pose estimate. In one embodiment, the exoskeleton device 510 uses the onboard sensors 513 to develop a real-time understanding of the user's pose. In other words, data from sensors 513 can be used to determine the configuration of the actuation units 110, which along with other sensor data can in turn be used to infer a user pose or body configuration estimate of the user 101 wearing the actuation units 110.

At times, and in some embodiments, it can be unrealistic or impossible for the exoskeleton system 100 to directly sense all important aspects of the system pose due to the sensing modalities not existing or their inability to be practically integrated into the hardware. As a result, the exoskeleton system 100 in some examples can rely on a fused understanding of the sensor information around an underlying model of the user's body and the exoskeleton system 100 the user is wearing. In one embodiment of a dual leg knee assistance exoskeleton system 100, the exoskeleton device 510 can use an underlying model of the user's lower extremity and torso body segments to enforce a relational constraint between the otherwise disconnected sensors 513. Such a model can allow the exoskeleton system 100 to understand the constrained motion of the two legs 102 in that they are mechanically connected through the user's kinematic chain created by the body. This approach can be used to ensure that the estimates for knee orientation are properly constrained and biomechanically valid. In various embodiments, the exoskeleton system 100 can include sensors 513 embedded in the exoskeleton device 510 and/or pneumatic system 520 to provide a fuller picture of the system posture. In yet another embodiment, the exoskeleton system 100 can include logical constraints that are unique to the application in an effort to provide additional constraints on the operation of the pose estimation. This can be desirable, in some embodiments, in conditions where ground truth information is unavailable such as highly dynamic actions, where the exoskeleton system 100 is denied an external GPS signal, or the earth's magnetic field is distorted.

In some embodiments, changes in configuration of the exoskeleton system 100 based location and/or location attributes can be performed automatically and/or with input from the user 101. For example, in some embodiments, the exoskeleton system 100 can provide one or more suggestions for a change in configuration based on location and/or location attributes and the user 101 can choose to accept such suggestions. In further embodiments, some or all configurations of the exoskeleton system 100 based location and/or location attributes can occur automatically without user interaction.

Various embodiments can include the collection and storage of data from the exoskeleton system 100 throughout operation. In one embodiment, this can include the live streaming of the data collected on the exoskeleton device 510 to a cloud storage location via the communication unit(s) 514 through an available wireless communication protocol or storage of such data on the memory 512 of the exoskeleton device 510, which may then be uploaded to another location via the communication unit(s) 514. For example, when the exoskeleton system 100 obtains a network connection, recorded data can be uploaded to the cloud at a communication rate that is supported by the available data connection. Various embodiments can include variations of this, but the use of monitoring software to collect and store data about the exoskeleton system 100 locally and/or remotely for retrieval at a later time for an exoskeleton system 100 such as this can be included in various embodiments.

In some embodiments, once such data has been recorded, it can be desirable to use the data for a variety of different applications. One such application can be the use of the data to develop further oversight functions on the exoskeleton system 100 in an effort to identify device system issues that are of note. One embodiment can be the use of the data to identify a specific exoskeleton system 100 or leg actuator unit 110 among a plurality, whose performance has varied significantly over a variety of uses. Another use of the data can be to provide it back to the user 101 to gain a better understanding of how they ski. One embodiment of this can be providing the data back to the user 101 through a mobile application that can allow the user 101 to review their use on a mobile device. Yet another use of such device data can be to synchronize playback of data with an external data stream to provide additional context. One embodiment is a system that incorporates the GPS data from a companion smartphone with the data stored natively on the device. Another embodiment can include the time synchronization of recorded video with the data stored that was obtained from the device 100. Various embodiments can use these methods for immediate use of data by the user to evaluate their own performance, for later retrieval by the user to understand behavior from the past, for users to compare with other users in-person or through an online profile, by developers to further the development of the system, and the like.

Another aspect of a method of operating an exoskeleton system 100 can include monitoring software configured for identifying user-specific traits. For example, the exoskeleton system 100 can provide an awareness of how a specific skier 101 operates in the exoskeleton system 100 and over time can develop a profile of the user's specific traits in an effort to maximize device performance for that user. One embodiment can include the exoskeleton system 100 identifying a user-specific use type in an effort to identify the use style or skill level of the specific user. Through an evaluation of the user form and stability during various actions (e.g., via analysis of data obtained from the sensors 513 or the like), the exoskeleton device 510 in some examples can identify if the user is highly skilled, novice, or beginner. This understanding of skill level or style can allow the exoskeleton system 100 to better tailor control references to the specific user.

In further embodiments, the exoskeleton system 100 can also use individualized information about a given user to build a profile of the user's biomechanic response to the exoskeleton system 100. One embodiment can include the exoskeleton system 100 collecting data regarding the user to develop an estimate of the individual user's knee strain in an effort to assist the user with understanding the burden the user has placed on his legs 102 throughout use. This can allow the exoskeleton system 100 to alert a user if the user has reached a historically significant amount of knee strain to alert the user that he may want to stop to spare himself potential pain or discomfort.

Another embodiment of individualized biomechanic response can be the system collecting data regarding the user to develop an individualized system model for the specific user. In such an embodiment the individualized model can be developed through a system ID (identification) method that evaluates the system performance with an underlying system model and can identify the best model parameters to fit the specific user. The system ID in such an embodiment can operate to estimate segment lengths and masses (e.g., of legs 102 or portions of the legs 102) to better define a dynamic user model. In another embodiment, these individualized model parameters can be used to deliver user specific control responses as a function of the user's specific masses and segment lengths. In some examples of a dynamic model, this can help significantly with the device's ability to account for dynamic forces during highly challenging activities.

In various embodiments, the exoskeleton system 100 can provide for various types of user interaction. For example, such interaction can include input from the user 101 as needed into the exoskeleton system 100 and the exoskeleton system 100 providing feedback to the user 101 to indicate changes in operation of the exoskeleton system 100, status of the exoskeleton system 100, and the like. As discussed herein, user input and/or output to the user can be provided via one or more user interface 515 of the exoskeleton device 510 or can include various other interfaces or devices such as a smartphone user device. Such one or more user interfaces 515 or devices can be located in various suitable locations such as on a backpack 155 (see e.g., FIG. 1), the pneumatic system 520, leg actuation units 110, or the like.

The exoskeleton system 100 can be configured to obtain intent from the user 101. For example, this can be accomplished through a variety of input devices that are either integrated directly with the other components of the exoskeleton system 100 (e.g., one or more user interface 515), or external and operably connected with the exoskeleton system 100 (e.g., a smartphone, wearable device, remote server, or the like). In one embodiment, a user interface 515 can comprise a button that is integrated directly into one or both of the leg actuation units 110 of the exoskeleton system 100. This single button can allow the user 101 to indicate a variety of inputs. In another embodiment, a user interface 515 can be configured to be provided through a torso-mounted lapel input device that is integrated with the exoskeleton device 510 and/or pneumatic system 520 of the exoskeleton system 100. In one example, such a user interface 515 can comprise a button that has a dedicated enable and disable functionality; a selection indicator dedicated to the user's desired power level (e.g., an amount or range of force applied by the leg actuator units 110); and a selector switch that can be dedicated to the amount of predictive intent to integrate into the control of the exoskeleton system 100. Such an embodiment of a user interface 515 can use a series of functionally locked buttons to provide the user 101 with a set of understood indicators that may be required for normal operation in some examples. Yet another embodiment can include a mobile device that is connected to the exoskeleton system 100 via a Bluetooth connection or other suitable wired or wireless connection. Use of a mobile device or smartphone as a user interface 515 can allow the user a far greater amount of input to the device due to the flexibility of the input method. Various embodiments can use the options listed above or combinations and variants thereof, but are in no way limited to the explicitly stated combinations of input methods and items.

The one or more user interface 515 can provide information to the user 101 to allow the user to appropriately use and operate the exoskeleton system 100. Such feedback can be in a variety of visual, haptic and/or audio methods including, but not limited to, feedback mechanisms integrated directly on one or both of the actuation units 110; feedback through operation of the actuation units 110; feedback through external items not integrated with the exoskeleton system 100 (e.g., a mobile device); and the like. Some embodiments can include integration of feedback lights in the actuation units 110, of the exoskeleton system 100. In one such embodiment, five multi-color lights are integrated into the knee joint 125 or other suitable location such that the user 101 can see the lights. These lights can be used to provide feedback of system errors, device power, successful operation of the device, and the like. In another embodiment, the exoskeleton system 100 can provide controlled feedback to the user to indicate specific pieces of information. In such embodiments, the exoskeleton system 100 can pulse the joint torque on one or both of the leg actuation units 110 to the maximum allowed torque when the user changes the maximum allowable user-desired torque, which can provide a haptic indicator of the torque settings. Another embodiment can use an external device such as a mobile device where the exoskeleton system 100 can provide alert notifications for device information such as operational errors, setting status, power status, and the like. Types of feedback can include, but are not limited to, lights, sounds, vibrations, notifications, and operational forces integrated in a variety of locations that the user 101 may be expected to interact with including the actuation units 110, pneumatic system 520, backpack 155, mobile devices, or other suitable methods of interactions such as a web interface, SMS text or email.

The communication unit 514 can include hardware and/or software that allows the exoskeleton system 100 to communicate with other devices, including a user device, a classification server, other exoskeleton systems 100, or the like, directly or via a network. For example, the exoskeleton system 100 can be configured to connect with a user device, which can be used to control the exoskeleton system 100, receive performance data from the exoskeleton system 100, facilitate updates to the exoskeleton system, and the like. Such communication can be wired and/or wireless communication.

In some embodiments, the sensors 513 can include any suitable type of sensor, and the sensors 513 can be located at a central location or can be distributed about the exoskeleton system 100. For example, in some embodiments, the exoskeleton system 100 can comprise a plurality of accelerometers, force sensors, position sensors, and the like, at various suitable positions, including at the arms 115, 120, joint 125, actuators 130 or any other location. Accordingly, in some examples, sensor data can correspond to a physical state of one or more actuators 130, a physical state of a portion of the exoskeleton system 100, a physical state of the exoskeleton system 100 generally, and the like. In some embodiments, the exoskeleton system 100 can include a global positioning system (GPS), camera, range sensing system, environmental sensors, elevation sensor, microphone, thermometer, or the like. In some embodiments, the exoskeleton system 100 can obtain sensor data from a user device such as a smartphone, or the like.

In some cases, it can be beneficial for the exoskeleton system 100 to generate or augment an understanding of a user 101 wearing the exoskeleton device 100, of the environment and/or operation of the exoskeleton system 100 through integrating various suitable sensors 515 into the exoskeleton system 100. One embodiment can include sensors 515 to measure and track biological indicators to observe various suitable aspects of user 101 (e.g., corresponding to fatigue and/or body vital functions) such as, body temperature, heart rate, respiratory rate, blood pressure, blood oxygenation saturation, expired CO₂, blood glucose level, gait speed, sweat rate, and the like.

In some embodiments, the exoskeleton system 100 can take advantage of the relatively close and reliable connectivity of such sensors 515 to the body of the user 101 to record system vitals and store them in an accessible format (e.g., at the exoskeleton device, a remote device, a remote server, or the like). Another embodiment can include environmental sensors 515 that can continuously or periodically measure the environment around the exoskeleton system 100 for various environmental conditions such as temperature, humidity, light level, barometric pressure, radioactivity, sound level, toxins, contaminants, or the like. In some examples, various sensors 515 may not be required for operation of the exoskeleton system 100 or directly used by operational control software, but can be stored for reporting to the user 101 (e.g., via an interface 515) or sending to a remote device, a remote server, or the like.

The pneumatic system 520 can comprise any suitable device or system that is operable to inflate and/or deflate the actuators 130 individually or as a group. For example, in one embodiment, the pneumatic system can comprise a diaphragm compressor as disclosed in related patent application Ser. No. 14/577,817 filed Dec. 19, 2014 or a pneumatic power transmission as discussed herein.

Various embodiments can include a power system 516 (See FIG. 5) that allows any suitable number of modular battery units to be integrated into the power system 516. Such a design can allow the exoskeleton system 100 to integrate any suitable number of modular batteries into the power system 516. Various embodiments can include a power system 516 having one or more integral battery units that are a permanent or semi-permanent part of an exoskeleton system 100. Additionally, various embodiments can include a power system 516 configured to obtain power from an external source such as power receptacles of a building, or the like.

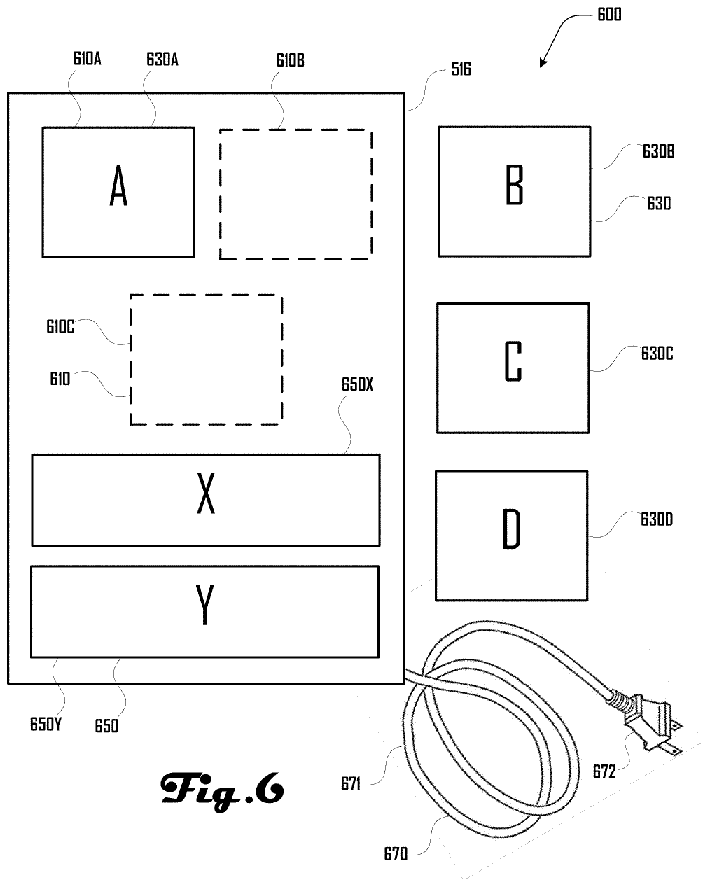

For example, FIG. 6 illustrates one example embodiment of a power system 516 and a modular battery set 600. The power system 516 comprises a first, second and third battery slot 610A, 610B, 610C with a first battery unit 630A shown disposed in the first battery slot 610A. The modular battery set 600 can comprise a plurality of modular battery units 630, including the first battery unit 630A, and a second, third and fourth battery unit 630B, 630C, 630D. The power system 516 can also comprise a first and second integral battery 650X, 650Y along with a power cord 670.

In various embodiments, the battery units 630 can be modular such that any of the battery units 630A, 630B, 630C, 630D can be coupled within any of the battery slots 610A, 610B, 610C. For example, the first battery unit 630A can be coupled with the first battery slot 610A as shown in FIG. 6, or could be coupled in the second or third battery slots 610B, 610C. Additionally, in various embodiments, one or more of the battery slots 610A, 610B, 610C can be filled by a battery unit 630 at a given time or all three battery slots 610A, 610B, 610C can be empty. Also, in various embodiments there is no order relationship between the battery slots 610A, 610B, 610C. In other words, in various embodiments the battery slots 610A, 610B, 610C need not be filled or have battery units 630 removed in any given order.

While various examples include a plurality of battery slots 610 that are the same where a set of battery units 630 can be interchangeably coupled to any of the plurality of slots 610, in some embodiments there can be battery slots 610 of different configurations, where only certain battery units 630 can be coupled with a given battery slot 610. Such an embodiment may be desirable where battery units 630 having different characteristics are desirable and having battery slots 610 of different configurations can be used to allow the correct battery units 630 to be coupled in the correct location.

Also, while some examples include a modular battery set 600 having a plurality of battery units 630 with the same size, shape and battery characteristics, some embodiments can include a modular battery set 600 having battery units 630 of different sizes, shapes and/or battery characteristics, where such battery units 630 can be interchangeably or modularly coupled to a plurality of battery slots 610. For example, battery units 630 having a larger power capacity may be physically larger than battery units 630 having a smaller power capacity. Accordingly, where a user 101 desires to carry less weight or to avoid large cumbersome batteries, the user can couple smaller battery units 630 to the exoskeleton device 100, but potentially at the expense of battery life and operation time. On the other hand, where longer battery life is important and size or weight of batteries 630 is not an issue, the use can couple larger battery units 630 to the exoskeleton device 100.

In another example, different battery units 630 can be configured for different types of performance of an exoskeleton device 100 and battery units 630 can be selected based on an expected activity, mission, task, or the like. For example, where a user 101 is expecting to walk a long period without making many dynamic movements and generally requiring a constant power output within a relatively narrow range, battery units 630 can be selected that are configured for long-term consistent current output. In another example, where a user 101 is expecting to make dynamic movements or otherwise use an exoskeleton system 100 in a way that may require high-power output or spikes of high-power output, battery units 630 can be selected which are configured to provide power to the exoskeleton system 100 in such a way.

Also, batteries (e.g., battery units 630 and integral batteries 650) can be of various suitable types including, rechargeable, semi-rechargeable or one-time use batteries. For example, batteries as discussed herein can include, lithium ion batteries, alkaline batteries, nickel-cadmium batteries, nickel-metal hydride batteries, lithium ion polymer batteries, lead-acid batteries, zinc-air batteries, and the like. Also, batteries as discussed herein can be single and/or multi-cell batteries. Additionally, the term battery should be construed to include, in some embodiments, any system that is configured to store and/or discharge energy, which can include capacitors, a nuclear energy source, a chemical energy source, a combustion energy source, a mechanical energy source, or the like.

The battery units 630 can be electrically coupled with the battery slots 610 in various suitable ways, including via a plug, socket, slip, tongue, shoe, rail, port, or the like. Accordingly, use of the term ‘slot’ should not be construed to imply the requirement for a specific structure of the battery slots 610 and battery units 630. Additionally, in various embodiments, the battery units 630 can be physically coupled with the battery slots 610 in various suitable ways, including a plug, socket, slip, tongue, shoe, rail, port, clip, strap, clasp, friction fit, threads, hook and loop tape (e.g., Velcro), or the like. In various embodiments, a physical coupling between a battery unit 630 and battery slot 610 can be the same or different from an electrical coupling between a battery unit 630 and battery slot 610.

Also, while the example of FIG. 6 illustrates one embodiment where a power system 516 comprises three battery slots 610A, 610B, 610C, it should be clear that further embodiments can comprise any suitable number of battery slots 610 such as 1, 2, 3, 4, 5, 6, 7, 8, 9, 10, 12, 15, 25, 50, 100, 200 and the like. In some embodiments battery slots 610 can be absent from the power system 516 or exoskeleton system 100. Also, while the example of FIG. 6 illustrates one embodiment where a modular battery set 600 comprises four battery units 630A, 630B, 630C, 630D it should be clear that further embodiments can comprise any suitable number of battery units 630 such as 1, 2, 3, 4, 5, 6, 7, 8, 9, 10, 12, 15, 25, 50, 100, 200 and the like. In some embodiments battery units 630 can be absent from the power system 516 or exoskeleton system 100.

Additionally, the example of FIG. 6 illustrates an embodiment of a power system 516 having a first and second integral battery 650X, 650Y, which can be a permanent or semi-permanent part of the power system 516 or exoskeleton system 100. In contrast to embodiments of modular battery units 630 that can be readily removed and coupled with battery slots 610 by a user 101, integral batteries 650 of various examples cannot be readily removed and coupled with power system 516 or exoskeleton system 100. For example, in some embodiments, integral batteries 650 can be coupled to the power system 516 or exoskeleton system 100 via screws, bolts, an adhesive, or be physically integral to or disposed within a portion of the power system 516 or exoskeleton system 100 such that the physical damage to the power system 516 or exoskeleton system 100 would be required to extract an integral battery 650.

Accordingly, it should be clear that various embodiments of modular battery units 630 can be readily and quickly removed and coupled with battery slots 610 without the aid of tools, substantial work, or damage to portions of the power system 516 or exoskeleton system 100, whereas integral batteries 650 of various embodiments are not configured to be readily and quickly removable without the aid of tools, substantial work, or damage to portions of the power system 516 or exoskeleton system 100. For example, in some embodiments, an integral battery 650 can be installed in the power system 516 or exoskeleton system 100 during construction of such components with the intention of the integral battery 650 only being discharged and recharged while coupled with the power system 516 or exoskeleton system 100 and not ever being replaced or only being replaced very rarely in cases where the integral battery 650 fails or is unable to suitably hold a charge, or the like. In contract, various embodiments of modular battery units 630 can be configured to be charged while coupled to a battery slot 610 or while separate from a battery slot 610 and configured to be readily and quickly coupled to and removed from battery slots 610 numerous times.

Also, while the example of FIG. 6 illustrates one embodiment where a power system 516 comprises two integral batteries 650, it should be clear that further embodiments can comprise any suitable number of integral batteries 650 such as 1, 2, 3, 4, 5, 6, 7, 8, 9, 10, 12, 15, 25, 50, 100, 200 and the like. In some embodiments integral batteries 650 can be absent from the power system 516 or exoskeleton system 100. Additionally, in some examples, one or more integral batteries 650 can comprise or be defined by capacitors.

Batteries (e.g., battery units 630 and integral batteries 650) can be disposed at various suitable locations of an exoskeleton device 100 and/or carried by a user 101 in various suitable ways. For example, in some embodiments, batteries and/or battery slots 610 can be disposed on or in a belt (e.g., worn around the waist of a user 101), a backpack 155, straps of a backpack 155, a bandolier, an actuation unit 110 (e.g., on an upper and/or lower arm 115, 120), a helmet, a shoe or boot, clothing such as pants or a jacket, body armor, body pack, or the like. For example, in some embodiments it can be desirable to have batteries distributed about the exoskeleton device 100 and/or body of the user 101 to provide for weight distribution, easy access to battery units 630, protection of batteries, heat dissipation, to be in proximity to elements being powered, and the like. In some embodiments, it can be desirable for batteries to be disposed on respective actuation units 110L, 110R to provide for weight balance and so that the weight of batteries is carried by the exoskeleton device 100 instead of by the user 101.

Additionally, as shown in the example of FIG. 6, the power system 516 can comprise a power cord 670, which can comprise a cord 671 and a plug 672. In various embodiments, the power cord 670 can be configured to couple with a power source external to the exoskeleton system 100, which can provide power to the exoskeleton system 100 that can be used to power various components of the exoskeleton system 100, charge one or more modular battery units 630, charge one or more integral batteries 650, or the like. For example, the plug 672 can be configured to couple with a conventional power receptacle of a building, vehicle or other external power source. Further embodiments can be configured to obtain power from portable generators, vehicle power, boat power, plane power, solar power, hydroelectric power, wind power, fuel cells, and the like. Also, while the example of FIG. 6 illustrates one embodiment where a power system 516 comprises one power cord 670, it should be clear that further embodiments can comprise any suitable number of power cords 670 or a power cord 670 can be absent from the power system 516 or exoskeleton system 100.

Such an architecture in some examples can allow a user 101 to operate with an exoskeleton system 100 that has only one battery unit 630 connected to the power system 516 for short duration tasks, and then connect additional battery units 630 to account for larger duration activities. In one embodiment, the user 101 of a powered wearable robotics knee system (e.g., an exoskeleton system 100) can connect a single battery unit 630 for intermittent use around the house because they have reliable access to additional battery units 630. Then, for use of the same powered wearable robotics knee system while outside of the house, the user 101 can connect three battery units 630 to the power system 516 to triple the battery capacity and extend the duration of operation of the wearable robotics knee system.

For example, referring to the embodiment of FIG. 6, a user 101 can connect a first battery unit 630A to the power system 516 as shown in FIG. 6, with additional battery units 630B, 630C, 630D being available for replacing the first battery unit 630A (e.g., in the first slot 610A, or in the second or third slots 610B, 610C) when the first battery unit 630A lacks sufficient power to power the system 100. However, where the user 101 wants to have a longer working time for the exoskeleton system 100 without having to replace or add additional battery units 630 to the exoskeleton system 100, the user can couple battery units 630 to all three battery slots 610A, 610B, 610C. Such a configuration can be desirable where the user 101 wants to be able to operate the exoskeleton system for a longer duration without the need to interact with the power system 516 or separately carry additional battery units 630.

In some examples, it can be desirable for a minimum set of batteries to be able to power a minimum set of performance capabilities for an exoskeleton system 100. Using FIG. 6 as an example, a minimum set of batteries could include the integral batteries 650A, 650B without any battery units 630 coupled to the power system 516; or the integral batteries 650A, 650B without one battery unit 630 coupled to the power system 516, or the like. In embodiments, where the power system 516 does not have integral batteries 650, a minimum set of batteries could be a single battery unit 630 coupled to the power system 516.

However, beyond such a minimum set of performance capabilities, the exoskeleton system 100 or user 101 can elect to use added battery power in a variety of ways. In one embodiment, an exoskeleton system 100 can use such additional integrated battery power to extend the duration of operation for an additional amount of time with the minimum set of performance capabilities (e.g., expending the same amount power for a greater duration based on additional power provided by additional battery units).

In another embodiment, the exoskeleton system 100 can use added battery capacity to allow the system 100 to expend more battery capacity during use of the exoskeleton system 100. In one example embodiment of an exoskeleton system 100, where a power system 516 has no integral batteries 650 (see FIG. 6) and three slots 610 for three modular battery units 630, the exoskeleton system 100 can increase the electrical limit of power allowed to be introduced through motors or actuators of the exoskeleton system 100, based on the number of modular battery units 630 coupled to the power system 516. For example, three battery units 630 in the three slots 610 can be used to increase the allowable maximum commanded current to system motors by 50% and doubling the operating duration of the exoskeleton system 100.

In yet another embodiment, the exoskeleton system 100 can use the additional power of three battery units 630 in the three slots 610 by increasing a set of available assisted maneuvers compared to a set of available assisted maneuvers for a low power configuration of only one battery unit 630 in one slot 610. In such an embodiment and in the case of one battery unit 630 installed, the exoskeleton system 100 can target assistance with sit to stand maneuvers, but with three battery units 630 installed, the exoskeleton system 100 can add assistance with the stance phase during walking and stair ascent. These embodiments can include, but are not limited to, using the additional power through any combination of increased duration and/or increased power capacity as desired across any selection of desired actions or system capacities. Such embodiments can be applied to power systems 516 comprising any suitable number of modular battery units 630 and/or integral batteries 650.

Embodiments can also include a configuration where a set of assisted maneuvers is reduced to no targeted behaviors and a single battery (e.g., a single battery unit 630 or integral battery 650) is only used to maintain operation of the power system 516, exoskeleton device 610, or portions thereof. For example, a single battery or minimal set of batteries simply provides minimal power to the system, but the exoskeleton system 100 does not support user movements until additional modular batteries 630 are coupled to the power system 516.

In various embodiments, a method of operating an exoskeleton system 100 can comprise determining by an exoskeleton device 510, a power configuration of the exoskeleton system 100 defined at least in part by a number of batteries coupled with a power system 516 and configuring the operating parameters of the exoskeleton system 100 based at least in part on the determined power configuration of the exoskeleton system 100. The exoskeleton device 510 can monitor the configuration of batteries coupled to the power system 516 and charge capacity of the batteries coupled to the power system 516 and change the operating parameters of the exoskeleton system 100 based on any changes.

For example, a power configuration can be determined based on various data, such as a charge of one or more batteries, a voltage associated with one or more batteries, a current associated with one or more batteries, or a number of batteries physically coupled to the power system 516. A number of batteries physically coupled to the power system 516 can be determined in various suitable ways, such as a switch that identifies a physical coupling between a battery and the power system 516 (e.g., a physical coupling of a battery unit 630 with a battery slot 610); identifying a non-zero amount of electrical current at a given location (e.g., at one or more battery slots 610), or the like. Determining the number of batteries coupled to a power system 516 can include modular battery units 630 and/or integral batteries 650. Additionally, in some embodiments, the exoskeleton system 100 can be configured to obtain various types of data regarding batteries via physical or wireless communication, such as a battery serial number, a battery type, a battery voltage, a battery current, a maximum battery charge capacity, a current battery charge state, a battery health state (e.g., operable or broken), or the like.

Operating parameters of the exoskeleton system 100 can be selected based on various power states including one or more of: a number of modular battery units 630 coupled to the power system 516; a number of integral battery units 650 coupled to the power system 516; an individual charge state of one or more batteries coupled to the power system 516; a collective charge state of one or more batteries coupled to the power system 516, and the like. Operating parameters of an exoskeleton system 100 that can be configured based on such power states can include: a set of available assisted maneuvers; a set of unavailable assisted maneuvers; a maximum power output for one or more assisted maneuvers; providing or not providing power to one or more actuators; drawing or not drawing power from a given battery, or the like.

In some examples, changing operating parameters based on a change in batteries coupled to the power system 516 can be immediate, or can occur on a delay. For example, where a user is hot-swapping batteries as discussed below, the exoskeleton device 100 can maintain a current set of operating parameters for a defined time period to allow the user 101 to remove and replace a battery unit 630, or the like.

In some examples it can be beneficial to allow battery units 630 to be safely replaced by the user 101 without powering down the exoskeleton system 100. In various examples, this is referred to as “hot-swapping” batteries where power remains live to the battery units 630 that remain connected to the power system 516 and then the exoskeleton system 100 begins to use new battery units 630 that are subsequently connected and while maintaining operation of the exoskeleton system 100.

In one embodiment this is accomplished through powering the exoskeleton system 100 with a set of a plurality of battery units 630 (see e.g., FIG. 6). In such an embodiment, the power system 516 can be configured to allow one or more of a plurality of coupled battery units 630 to be removed from the power system 516 while the system logic remains operational (e.g., while the exoskeleton device 510 remains powered and active). In another embodiment, the power system 516 is designed such that when one or more of a plurality of coupled battery units 630 are to be removed from the power system 516, the exoskeleton system 100 remains fully operational and capable of providing high power actuation to the user 101 (e.g., the exoskeleton device 510 and pneumatic system 520 remain powered and active). For example, in one specific embodiment, a wearable robotic exoskeleton system 100 has two battery units 630 connected to a power system 516 and the user 101 is able to disconnect one of the battery units 630 and then reconnect a new battery unit 630 without disrupting the power access to the exoskeleton device 100. In various embodiments, not disrupting access to power can constitute but is not limited to that the exoskeleton system 100 continues to operate the same way, or that the exoskeleton system 100 has defined operating conditions within each individual battery configuration.

In yet another embodiment, batteries can be configured as shown in the example of FIG. 6 where one or more battery units 630 are accessible and removable by a user 101 and one or more integral batteries 650 are inaccessible to the user 101. In various examples, some or all of the one or more battery units 630 can be removed from the power system 516 and the one or more integral batteries 650 can be used to maintain operation of the exoskeleton system 100 for an amount of time.

In various embodiments only a subset of batteries coupled to a power system can be used at a given time. In some embodiments, some batteries can be considered primary, secondary, tertiary or backup batteries. For example in one embodiment one or more integral batteries 650 is not used to power the exoskeleton system 100 in various operating states and power is only drawn from such one or more integral batteries 650 when one or more battery units 630 are being removed and replaced (e.g., during hot-swapping); when no battery units 630 are coupled to the power system 516; when one or more battery units 630 runs out of power, fails, or provides power inconsistently, or the like.

For example in some embodiments, power backup may be stored on the device and not expended during normal operation. However, if the user indicates or the exoskeleton system 100 detects an emergency need for the exoskeleton system 100 to operate when another power source is not available or desirable to use, the exoskeleton system 100 system can tap into this emergency power backup to provide full or limited operation for a limited amount of time. In such an embodiment, the exoskeleton system 100 may indicate that it has depleted its electrical power source for normal operation despite still having the emergency power backup available. It should be noted that the systems and methods to achieve this emergency power backup can vary significantly and can include but are not limited to one or both of: reserving a defined percentage of the central battery, or having a second independent battery that is not depleted during normal operation.

In various embodiments it may be advantageous to integrate the battery units 630 and/or integral batteries 650 into the mechanical system of an exoskeleton system 100 in various ways. In one embodiment, the one or more integral batteries 650 are mechanically integrated within the structure of one or more actuator units 110, exoskeleton devices 510, pneumatic systems 520, or the like such that such one or more integral batteries 650 are not accessible by the user 101. In some examples, (see e.g., FIG. 6) there are two integral batteries 650 integrated within the structure of an exoskeleton system 100. Another embodiment can comprise batteries that are all external to the structure of the exoskeleton system 100. In one such a case, the mechanical system of the exoskeleton system 100 can be enclosed and one or more external-facing battery slot 610 allows the user 101 to connect a selected number of battery units 630 for a targeted application. In yet another embodiment, the exoskeleton system 100 includes a combination of mechanically integrated batteries (e.g., integral batteries 650) and externally connected battery units (e.g., battery units 630). Various embodiments can include but are not limited to any combination of internally configured and externally configured battery units as discussed herein.

In some embodiments, it may be beneficial to have various specific configurations that individual batteries are designed to meet. In one embodiment, the wearable robotic exoskeleton system 100 includes an integral battery 650 and a battery modular unit 630 that is coupled external to the hardware of the exoskeleton system 100 via a battery slot 610. In such an embodiment, the integral battery 650 can be designed to meet the stricter requirements of air travel such that with only one battery the exoskeleton system 100 is able to operate within the guidelines of the Federal Aviation Administration (FAA). The external battery unit 630 can be sized to be significantly larger such that the exoskeleton system 100 can operate for a full day of operation. As a result, the user 101 can disconnect the external battery unit 630 and remain within the required specifications for operation while on an airplane based on FAA regulations and then reconnect the external battery unit 630 after the flight to assist with a full day of normal assistance.

For example, FAA regulations can require that Lithium metal (non-rechargeable) batteries are limited to 2 grams of lithium per battery with Lithium ion (rechargeable) batteries being limited to a rating of 100 watt hours (Wh) per battery. However, passengers may also carry up to two spare larger lithium ion batteries (101-160 Wh) or Lithium metal batteries (2-8 grams). In various embodiments, it can be desirable for an exoskeleton power system 516 and/or battery system set 600 to be compliant with FAA regulations such that an exoskeleton system 100 can be suitably used during a flight while also being able to carry additional backup batteries on a flight in compliance with FAA regulations to provide addition capacity to the exoskeleton system 100 during or after the flight.

For example, one embodiment can comprise a first integral and/or removable battery (e.g., integral battery 650 or battery unit 630) that is limited to a rating of 100 watt hours (Wh), and one or two spare battery units 630 that each have a rating of between 101 and 160 Wh, less than 160 Wh, or the like. Further embodiments can comprise any suitable plurality of spare battery units 630 that each have a rating of between 101-160 Wh, less than 160 Wh, or the like.

Further embodiments can be configured to comply with one or more applicable laws of various jurisdiction on the transport of batteries in various scenarios such as commercial airline travel, private airline travel, military airline travel, shipping of batteries and related systems, and travel via various vehicles such as boats, ships, trains, public transportation, space travel, or the like.

For example, the European Aviation Safety Agency (EASA) can require that a primary battery (e.g., integral battery 650 or battery unit 630) must not exceed a Watt-hour (Wh) rating of 100 Wh or 2 grams of lithium content (with the first limit for rechargeable lithium-ion batteries and the second for lithium metal batteries, which are usually not rechargeable). If the Wh is higher than 100 but not higher than 160, a user may need an approval from an airline operator to carry the battery or exoskeleton system including the battery. Transport of any item with a battery that exceeds 160 Wh may be prohibited under EASA regulations. Spare batteries or a power bank for an exoskeleton device 100 may be allowed, but EASA regulations may require that such batteries never be in checked baggage and/or they must be individually protected to prevent short circuits (e.g., with insulating the terminals with tape, putting each battery in a plastic bag, or using any other appropriate way). The limits in for such spare batteries terms of Wh and lithium content under EASA regulations can be the same as above for a primary battery.

Various embodiments can be configured to comply with one or more sets of such battery transportation regulations now implemented or in the future. The regulations of the FAA, EASA, European Civil Aviation Conference (ECAC), European Organization for Safety of Air Navigation (EUROCONTROL), International Civil Aviation Organization (ICAO) Joint Aviation Authorities (JAA), for example, and other relevant authorities are hereby incorporated by reference in their entirety and for all purposes.

For example, some embodiments can include a primary battery (e.g., integral battery 650 or battery unit 630) that does not exceed a Watt-hour (Wh) rating of 50 Wh, 60 Wh, 70 Wh, 80 Wh, 90 Wh, 100 Wh, 110 Wh, 120 Wh, 130 Wh, 140 Wh, 150 Wh, 160 Wh, 170 Wh, 180 Wh, 190 Wh, 200 Wh, and the like. Some embodiments, may include no more than one, no more than two, no more than three such integral batteries 650 or battery units 630. Additionally, various embodiments can include one or more removable battery units 630 that do not exceed a Watt-hour (Wh) rating of 50 Wh, 60 Wh, 70 Wh, 80 Wh, 90 Wh, 100 Wh, 110 Wh, 120 Wh, 130 Wh, 140 Wh, 150 Wh, 160 Wh, 170 Wh, 180 Wh, 190 Wh, 200 Wh, and the like. Some embodiments, may include no more than one, no more than two, no more than three such battery units 630. Additionally, capacity of batteries can be expressed in various suitable ways including battery voltage by Amp hours (Ah), and the like.

In another embodiment, an exoskeleton system 100 can have two sizes of external battery units 630 that are sized to support four and eight hours of normal operation respectively. In such a case, the users can elect which battery unit 630 they want to connect to the system based on their desired use specifications. It should be noted that configurations of batteries and/or power systems 516 can be modified based on various suitable factors including: total stored energy, total battery cells, total mass, total dischargeable current, duration of operation, and the like.

In some cases it can be beneficial for the power usage from batteries to be designed in certain ways. In one embodiment, a battery management system (e.g., of the exoskeleton device 510 or power system 516) manages the power draw from multiple battery units 630 coupled to the power system 516 such that an even amount of energy is pulled from each battery unit 630. In such an embodiment, an exoskeleton system 100 with two battery units 630 installed, both at 100% charge, could deplete both battery units 630 evenly to 60% charge for both battery units 630 after two hours of operation.

In another embodiment, a power system 516 can be configured with one integral battery 650 that is integrated internally to the structure of the exoskeleton system 100 and a battery unit 630 that is removably connected to the exoskeleton system externally via a battery slot 610. A battery management system, in some examples, can manage the power draw from the integral battery 650 and removable external battery unit 630 such that the power is drawn from the external battery unit 630 first. In such an embodiment, with the integral battery 650 and external battery unit 630 both initially with 100% charge, the exoskeleton system 100 could discharge the external battery unit 630 to 20% charge after two hours of operation while the internal battery 650 would remain at 100%.

In yet another embodiment, the exoskeleton system 100 can be configured such that the charge of one or more integral batteries 650 is maximized. For example, a battery management system can have a primary or secondary goal of charging an integral battery 650 that is installed internally to the hardware such that the integral battery 650 is targeted to always be fully charged. In such an embodiment, an exoskeleton system 100 can have an integral battery 650 that is initially at 90% charge and an external removable battery unit 630 that is initially at 100% charge. The external removable battery unit 630 can be depleted to 10% charge and the integral battery 650 can be charged to 100% after two hours of operation, with the charging being based on power from the external removable battery unit 630.

In another embodiment one or more battery units 630 and/or one or more integral batteries 650 can be charged by an external power source such as, but not limited to, a wall outlet via a power cord 670, or the like. This can provide the advantage of only needing one operation (i.e., plugging into the charger) instead of needing to charge each battery individually with one or more separate chargers. In such an embodiment, when the one or more battery units 630 and one or more integral batteries 650 are charging from an external power source, a battery management system on an exoskeleton system 100 can prioritize charging the integral batteries 650 before the removable battery units 630.

In addition to one or more battery units 630 and/or one or more integral batteries 650 of an exoskeleton system 100 being charged by an external power source via a power cord 670, in some embodiments such batteries can be charged or the exoskeleton system 100 can be powered by an external wireless power system. For example, where exoskeleton systems 100 are being operated by a user 101 in a warehouse, the warehouse can comprise a wireless charging system throughout the warehouse that provides power to the exoskeleton system 100 wirelessly via electromagnetic induction, magnetic resonance, electric field coupling, radio reception, or the like. Such an embodiment can be desirable to allow exoskeleton systems 100 to operate indefinitely or for extended periods without batteries needing to be replaced or charged via an external power source (e.g., via a power cord 670).

Another component of some embodiments of an exoskeleton system 100 can be a mobile power pack that provides the operational power for one or more actuation units 110 of the exoskeleton system 100. In one preferred embodiment, such a power pack contains a compressor and batteries that can be used for the continued operation of pneumatic actuation of the system 100. The contents of such a power pack in some examples can be strongly correlated to the specific actuation approach configured to be used in the specific embodiment. In some embodiments, the power pack may only contain batteries which may be suitable in an electromechanically actuated system. Various embodiments of a power pack can include but are not limited to a combination of the following items: pneumatic compressor, batteries, stored high-pressure pneumatic chamber, hydraulic pump, pneumatic safety components, electric motor, electric motor drivers, microprocessor, and the like. For example, in some embodiments, a power pack can comprise some or all elements of an exoskeleton device 510 and pneumatic system 520.

Components such as a power pack, exoskeleton device 510, power system 516, pneumatic system 520, and the like, can be configured on the body of a user 101 in a variety of suitable ways. One preferred embodiment is the inclusion of a power pack, power system 516, or portion thereof, in a torso worn pack that is not operably coupled to the actuation units 110 in any manner that would transmit substantial mechanical forces to the actuation units 110. In such an embodiment, a power pack, power system 516, or portion thereof can be configured to be worn by the user in a shoulder bag that has no substantial mechanical integration with the actuation units 110. Another embodiment includes the integration of a power pack, power system 516, or portion thereof into the actuation units 110 themselves. Various embodiments can include but are not limited to the following configurations: torso-mounted in a backpack, torso-mounted in a messenger bag, hip-mounted bag, mounted to the leg, integrated into one or more actuation units 110, or the like. It is also possible to separate components of a power pack, power system 516, exoskeleton device 510, pneumatic system 520, and the like, and disperse such components into various configurations or locations on the user 101 and/or exoskeleton device 100. One embodiment can configure a pneumatic compressor on the torso of the user 101 and then integrate batteries into one or more actuation units 110 of the exoskeleton system 100.

One aspect of a power pack in various examples is that the power pack or portions thereof can be connected to one or more actuation units 110 in such a manner as to pass the operable system power (e.g., electric and/or fluidic power) to the one or more actuation units 110 for operation. One preferred embodiment is the use of electrical cables to connect a power system 516 and one or more actuation units 110. Other embodiments can use electrical cables and a pneumatic line 145 to deliver electrical power and pneumatic power to the one or more actuation units 110. Various embodiments can include connections such as: pneumatic hosing, hydraulic hosing, electrical cables, wireless communication, wireless power transfer, and the like.

In some embodiments, it can be desirable to include secondary features that extend the capabilities of a cable connection between one or more actuation units 110 and the power pack, power system 516, exoskeleton device 510, pneumatic system 520, and the like. One preferred embodiment includes retractable cables that are configured to have a small mechanical retention force to maintain cables that are pulled tight against the user 101 with reduced slack remaining in the cable. Various embodiments can include, but are not limited to, a combination of the following secondary features: retractable cables, a single cable including both fluidic and electrical power, magnetically-connected electrical cables, mechanical quick releases, breakaway connections designed to release at a specified pull force, integration into mechanical retention features on the user's clothing, and the like. Yet another embodiment can include routing cables in such a way as to minimize geometric differences between the user 101 and the cable lengths. One such embodiment in a dual knee configuration with a torso power pack can include routing the cables along the lower torso of the user 101 to connect the right side of the power pack bag with the left knee actuation unit 110L and the left side of the power pack bag with the right knee actuation unit 110R. Such a routing can allow the geometric differences in length throughout the user's normal range of motion during use of the exoskeleton system 100.

One feature that can be a concern in some examples is the need for proper heat management of the power pack, power system 516, exoskeleton device 510, pneumatic system 520, and the like. As a result, there are a variety of features that can be integrated specifically for the benefit of controlling heat. One preferred embodiment integrates exposed heat sinks to the environment that allow the power pack, power system 516, exoskeleton device 510, pneumatic system 520, and the like, to dispel heat directly to the environment through unforced cooling using ambient airflow. Another embodiment directs the ambient air through internal air channels in the power pack, power system 516, exoskeleton device 510, pneumatic system 520, or the like to allow for internal cooling. Yet another embodiment can extend upon this capability by introducing scoops on the power pack, power system 516, exoskeleton device 510, pneumatic system 520, or the like, in an effort to allow air flow through internal channels. Various embodiments can include: exposed heat sinks that are directly connected to a high heat component, a water-cooled or fluid-cooled heat management system, forced air cooling through the introduction of a powered fan or blower, external shielded heat sinks to protect heat sinks from direct contact by a user, and the like.

Another aspect of various embodiments of the power pack, power system 516, exoskeleton device 510, pneumatic system 520, and the like is noise profile during operation of the exoskeleton system 100. Some embodiments include individual or a combination of specific design modifications to mitigate the sound profile of various components of the exoskeleton system 100. One embodiment is the inclusion of vibration dampening in the mounting of any high-noise components such as a pneumatic compressor, or the like. In such an example case, the compressor can be mounted within a power pack box with a series of rubber standoffs to provide a visco-elastic standoff between the compressor and the power pack structure to mitigate vibration and noise propagation. Another embodiment is the design of a frequency-specific structure that can provide ample vibration resistance through a set of high-concern target frequencies. Yet another embodiment is the inclusion of an internal routing system to control the porting of the compressor for a pneumatic system 520. Such an embodiment can include directing the exhaust of the compressor through the pneumatic system 520 to a specified exhaust port, and pulling in ambient air from a dedicated inlet port on a power pack box. Various embodiments can use any collection of, but are not limited to, the examples presented above.

In a modular configuration, in some embodiments it may be required that a single power pack, power system 516, exoskeleton device 510, pneumatic system 520, or the like, be configured to support the power requirements of various potential configurations of an exoskeleton system 100. One preferred configuration is a power pack, power system 516, exoskeleton device 510, pneumatic system 520, or the like that could be asked to power a dual knee configuration or a single knee configuration (e.g., an exoskeleton system 100 having one or two actuation units 110). In various embodiments, such a power pack, power system 516, exoskeleton device 510, pneumatic system 520, or the like, would need to support the power requirements of both configurations and then appropriately direct power (e.g., fluidic and/or electrical power) to operate as expected in any configuration required. Various embodiments exist to support the array of potential modular system configurations, such as multiple batteries as discussed herein.

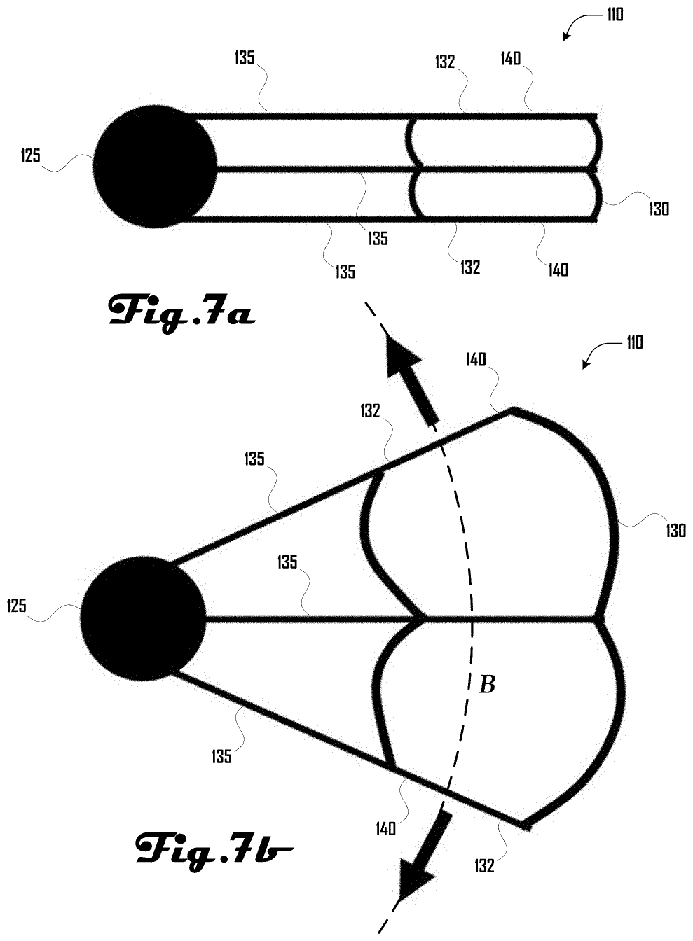

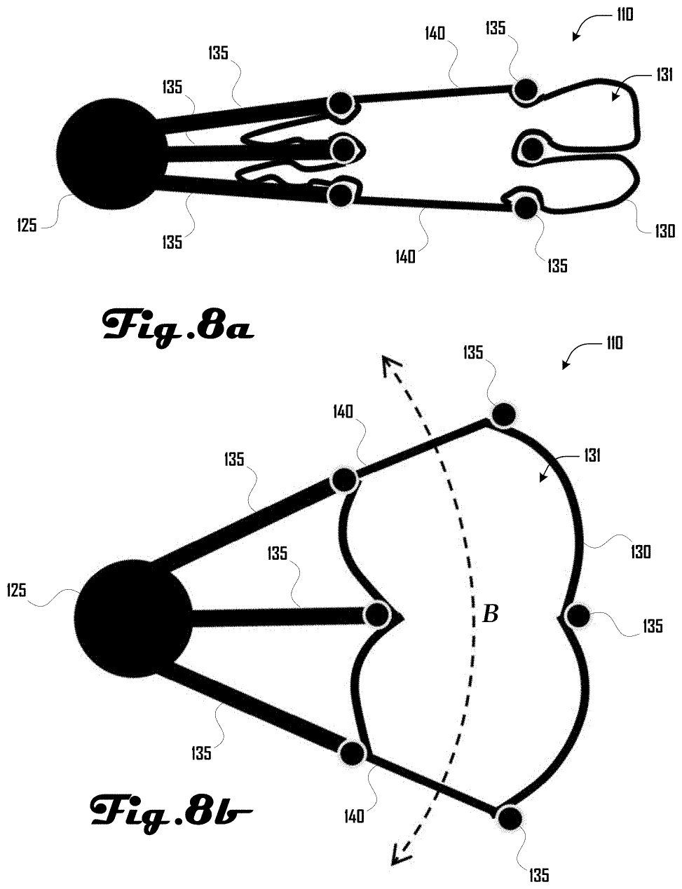

Turning to FIGS. 7a, 7b, 8a and 8b, examples of a leg actuator unit 110 can include the joint 125, bellows 130, constraint ribs 135, and base plates 140. More specifically, FIG. 7a illustrates a side view of a leg actuator unit 110 in a compressed configuration and FIG. 7b illustrates a side view of the leg actuator unit 110 of FIG. 7a in an expanded configuration. FIG. 8a illustrates a cross-sectional side view of a leg actuator unit 110 in a compressed configuration and FIG. 8b illustrates a cross-sectional side view of the leg actuator unit 110 of FIG. 8a in an expanded configuration.

As shown in FIGS. 7a, 7b, 8a and 8b, the joint 125 can have a plurality of constraint ribs 135 extending from and coupled to the joint 125, which surround or abut a portion of the bellows 130. For example, in some embodiments, constraint ribs 135 can abut the ends 132 of the bellows 130 and can define some or all of the base plates 140 that the ends 132 of the bellows 130 can push against. However, in some examples, the base plates 140 can be separate and/or different elements than the constraint ribs 135 (e.g., as shown in FIG. 1). Additionally, one or more constraint ribs 135 can be disposed between ends 132 of the bellows 130. For example, FIGS. 7a, 7b, 8a and 8b illustrate one constraint rib 135 disposed between ends 132 of the bellows 130; however, further embodiments can include any suitable number of constraint ribs 135 disposed between ends of the bellows 130, including 1, 2, 3, 4, 5, 6, 7, 8, 9, 10, 15, 20, 25, 30, 50, 100 and the like. In some embodiments, constraint ribs can be absent.

As shown in cross sections of FIGS. 8a and 8b, the bellows 130 can define a cavity 131 that can be filled with fluid (e.g., air), to expand the bellow 130, which can cause the bellows to elongate along axis B as shown in FIGS. 7b and 8b. For example, increasing a pressure and/or volume of fluid in the bellows 130 shown in FIG. 7a can cause the bellows 130 to expand to the configuration shown in FIG. 7b. Similarly, increasing a pressure and/or volume of fluid in the bellows 130 shown in FIG. 8a can cause the bellows 130 to expand to the configuration shown in FIG. 8b. For clarity, the use of the term ‘bellows’ is to describe a component in the described actuator unit 110 and is not intended to limit the geometry of the component. The bellows 130 can be constructed with a variety of geometries including but not limited to: a constant cylindrical tube, a cylinder of varying cross-sectional area, a 3-D woven geometry that inflates to a defined arc shape, and the like. The term ‘bellows’ should not be construed to necessary include a structure having convolutions.

Alternatively, decreasing a pressure and/or volume of fluid in the bellows 130 shown in FIG. 7b can cause the bellows 130 to contract to the configuration shown in FIG. 7a. Similarly, decreasing a pressure and/or volume of fluid in the bellows 130 shown in FIG. 8b can cause the bellows 130 to contract to the configuration shown in FIG. 8a. Such increasing or decreasing of a pressure or volume of fluid in the bellows 130 can be performed by pneumatic system 520 and pneumatic lines 145 of the exoskeleton system 100, which can be controlled by the exoskeleton device 510 (see FIG. 5).

In one preferred embodiment, the bellows 130 can be inflated with air; however, in further embodiments, any suitable fluid can be used to inflate the bellows 130. For example, gasses including oxygen, helium, nitrogen, and/or argon, or the like can be used to inflate and/or deflate the bellows 130. In further embodiments, a liquid such as water, an oil, or the like can be used to inflate the bellows 130. Additionally, while some examples discussed herein relate to introducing and removing fluid from a bellows 130 to change the pressure within the bellows 130, further examples can include heating and/or cooling a fluid to modify a pressure within the bellows 130.

As shown in FIGS. 7a, 7b, 8a and 8b, the constraint ribs 135 can support and constrain the bellows 130. For example, inflating the bellows 130 cause the bellows 130 expand along a length of the bellows 130 and also cause the bellows 130 to expand radially. The constraint ribs 135 can constrain radial expansion of a portion of the bellows 130. Additionally, as discussed herein, the bellows 130 comprise a material that is flexible in one or more directions and the constraint ribs 135 can control the direction of linear expansion of the bellows 130. For example, in some embodiments, without constraint ribs 135 or other constraint structures the bellows 130 would herniate or bend out of axis uncontrollably such that suitable force would not be applied to the base plates 140 such that the arms 115, 120 would not be suitably or controllably actuated. Accordingly, in various embodiments, the constraint ribs 135 can be desirable to generate a consistent and controllable axis of expansion B for the bellows 130 as they are inflated and/or deflated.

In some examples, the bellows 130 in a deflated configuration can substantially extend past a radial edge of the constraint ribs 135 and can retract during inflation to extend less past the radial edge of the constraint ribs 135, to extend to the radial edge of the constraint ribs 135, or to not extend less past the radial edge of the constraint ribs 135. For example, FIG. 8a illustrates a compressed configuration of the bellows 130 where the bellows 130 substantially extend past a radial edge of the constraint ribs 135 and FIG. 8b illustrates the bellows 130 retracting during inflation to extend less past the radial edge of the constraint ribs 135 in an inflated configuration of the bellows 130.

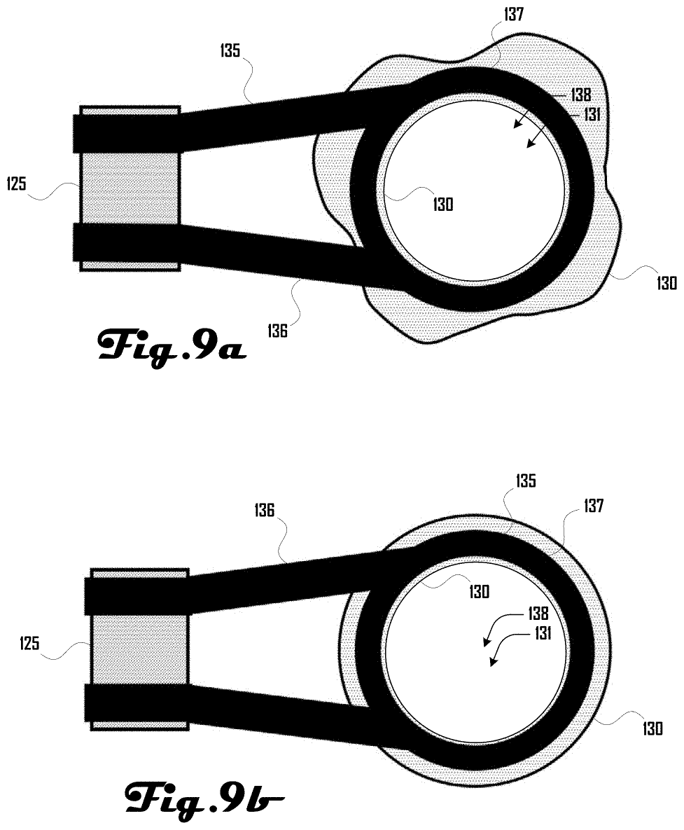

Similarly, FIG. 9a illustrates a top view of a compressed configuration of bellows 130 where the bellows 130 substantially extend past a radial edge of constraint ribs 135 and FIG. 9b illustrates a top view where the bellows 130 retract during inflation to extend less past the radial edge of the constraint ribs 135 in an inflated configuration of the bellows 130.

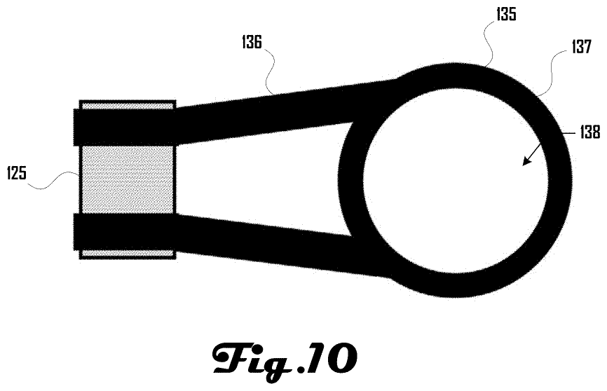

Constraint ribs 135 can be configured in various suitable ways. For example, FIGS. 9a, 9b and 10 illustrate a top view of an example embodiment of a constraint rib 135 having a pair of rib arms 136 that extend from the joint 125 and couple with a circular rib ring 137 that defines a rib cavity 138 through which a portion of the bellows 130 can extend (e.g., as shown in FIGS. 8a, 8b, 9a and 9b). In various examples, the one or more constraint ribs 135 can be a substantially planar element with the rib arms 136 and rib ring 137 being disposed within a common plane.

In further embodiments, the one or more constraint ribs 135 can have any other suitable configuration. For example, some embodiments can have any suitable number of rib arms 136, including one, two, three, four, five, or the like. Additionally, the rib ring 137 can have various suitable shapes and need not be circular, including one or both of an inner edge that defines the rib cavity 138 or an outer edge of the rib ring 137.

In various embodiments, the constraining ribs 135 can be configured to direct the motion of the bellows 130 through a swept path about some instantaneous center (which may or may not be fixed in space) and/or to prevent motion of the bellows 130 in undesired directions, such as out-of-plane buckling. As a result, the number of constraining ribs 135 included in some embodiments can vary depending on the specific geometry and loading of the leg actuator unit 110. Examples can range from one constraining rib 135 up to any suitable number of constraining ribs 135; according, the number of constraining ribs 135 should not be taken to limit the applicability of the invention. Additionally, constraining ribs 135 can be absent in some embodiments.

The one or more constraining ribs 135 can be constructed in a variety of ways. For example the one or more constraining ribs 135 can vary in construction on a given leg actuator unit 110, and/or may or may not require attachment to the joint structure 125. In various embodiments, the constraining ribs 135 can be constructed as an integral component of a central rotary joint structure 125. An example embodiment of such a structure can include a mechanical rotary pin joint, where the constraining ribs 135 are connected to and can pivot about the joint 125 at one end of the joint 125, and are attached to an inextensible outer layer of the bellows 130 at the other end. In another set of embodiments, the constraining ribs 135 can be constructed in the form of a single flexural structure that directs the motion of the bellows 130 throughout the range of motion for the leg actuator unit 110. Another example embodiment uses a flexural constraining rib 135 that is not connected integrally to the joint structure 125 but is instead attached externally to a previously assembled joint structure 125. Another example embodiment can comprise the constraint rib 125 being composed of pieces of fabric wrapped around the bellows 130 and attached to the joint structure 125, acting like a hammock to restrict and/or guide the motion of the bellows 130. There are additional methods available for constructing the constraining ribs 135 that can be used in additional embodiments that include but are not limited to a linkage, a rotational flexure connected around the joint 125, and the like.

In some examples, a design consideration for constraining ribs 135 can be how the one or more constraining ribs 125 interact with the bellows 130 to guide the path of the bellows 130. In various embodiments, the constraining ribs 135 can be fixed to the bellows 130 at predefined locations along the length of the bellows 130. One or more constraining ribs 135 can be coupled to the bellows 130 in various suitable ways, including but not limited to sewing, mechanical clamps, geometric interference, direct integration, and the like. In other embodiments, the constraining ribs 135 can be configured such that the constraining ribs 135 float along the length of the bellows 130 and are not fixed to the bellows 130 at predetermined connection points. In some embodiments, the constraining ribs 135 can be configured to restrict a cross sectional area of the bellows 130. An example embodiment can include a tubular bellows 130 attached to a constraining rib 135 that has an oval cross section, which in some examples can be a configuration to reduce the width of the bellows 130 at that location when the bellows 130 is inflated.

The bellows 130 can have various functions in some embodiments, including containing operating fluid of the leg actuator unit 110, resisting forces associated with operating pressure of the leg actuator unit 110, and the like. In various examples, the leg actuator unit 110 can operate at a fluid pressure above, below or at about ambient pressure. In various embodiments, bellows 130 can comprise one or more flexible, yet inextensible or practically inextensible materials in order to resist expansion (e.g., beyond what is desired in directions other than an intended direction of force application or motion) of the bellows 130 beyond what is desired when pressurized above ambient pressure. Additionally, the bellows 130 can comprise an impermeable or semi-impermeable material in order to contain the actuator fluid.

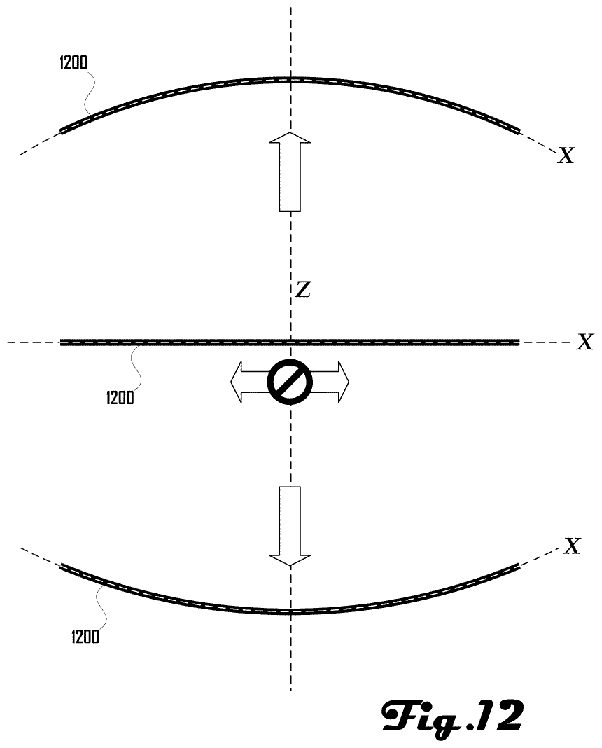

For example, in some embodiments, the bellows 130 can comprise a flexible sheet material such as woven nylon, rubber, polychloroprene, a plastic, latex, a fabric, or the like. Accordingly, in some embodiments, bellows 130 can be made of a planar material that is substantially inextensible along one or more plane axes of the planar material while being flexible in other directions. For example, FIG. 12 illustrates a side view of a planar material 1200 (e.g., a fabric) that is substantially inextensible along axis X that is coincident with the plane of the material 1200, yet flexible in other directions, including axis Z. In the example of FIG. 12, the material 1200 is shown flexing upward and downward along axis Z while being inextensible along axis X. In various embodiments, the material 1200 can also be inextensible along an axis Y (not shown) that is also coincident with the plane of the material 1200 like axis X and perpendicular to axis X.

In some embodiments, the bellows 130 can be made of a non-planar woven material that is inextensible along one or more axes of the material. For example, in one embodiment the bellows 130 can comprise a woven fabric tube. Woven fabric material can provide inextensibility along the length of the bellows 130 and in the circumferential direction. Such embodiments can still able to be configured along the body of the user 101 to align with the axis of a desired joint on the body 101 (e.g., the knee 103).

In various embodiments, the bellows 130 can develop its resulting force by using a constrained internal surface length and/or external surface length that are a constrained distance away from each other (e.g. due to an inextensible material as discussed above). In some examples, such a design can allow the actuator to contract on bellows 130, but when pressurized to a certain threshold, the bellows 130 can direct the forces axially by pressing on the plates 140 of the leg actuator unit 110 because there is no ability for the bellows 130 to expand further in volume otherwise due to being unable to extend its length past a maximum length defined by the body of the bellows 130.

In other words, the bellows 130 can comprise a substantially inextensible textile envelope that defines a chamber that is made fluid-impermeable by a fluid-impermeable bladder contained in the substantially inextensible textile envelope and/or a fluid-impermeable structure incorporated into the substantially inextensible textile envelope. The substantially inextensible textile envelope can have a predetermined geometry and a non-linear equilibrium state at a displacement that provides a mechanical stop upon pressurization of the chamber to prevent excessive displacement of the substantially inextensible textile actuator.

In some embodiments, the bellows 130 can include an envelope that consists or consists essentially of inextensible textiles (e.g., inextensible knits, woven, non-woven, etc.) that can prescribe various suitable movements as discussed herein. Inextensible textile bellows 130 can be designed with specific equilibrium states (e.g., end states or shapes where they are stable despite increasing pressure), pressure/stiffness ratios, and motion paths. Inextensible textile bellows 130 in some examples can be configured accurately delivering high forces because inextensible materials can allow greater control over directionality of the forces.

Accordingly, some embodiments of inextensible textile bellows 130 can have a pre-determined geometry that produces displacement mostly via a change in the geometry between the uninflated shape and the pre-determined geometry of its equilibrium state (e.g., fully inflated shape) due to displacement of the textile envelope rather than via stretching of the textile envelope during a relative increase in pressure inside the chamber; in various embodiments, this can be achieved by using inextensible materials in the construction of the envelope of the bellows 130. As discussed herein, in some examples “inextensible” or “substantially inextensible” can be defined as expansion by no more than 10%, no more than 5%, or no more than 1% in one or more direction.

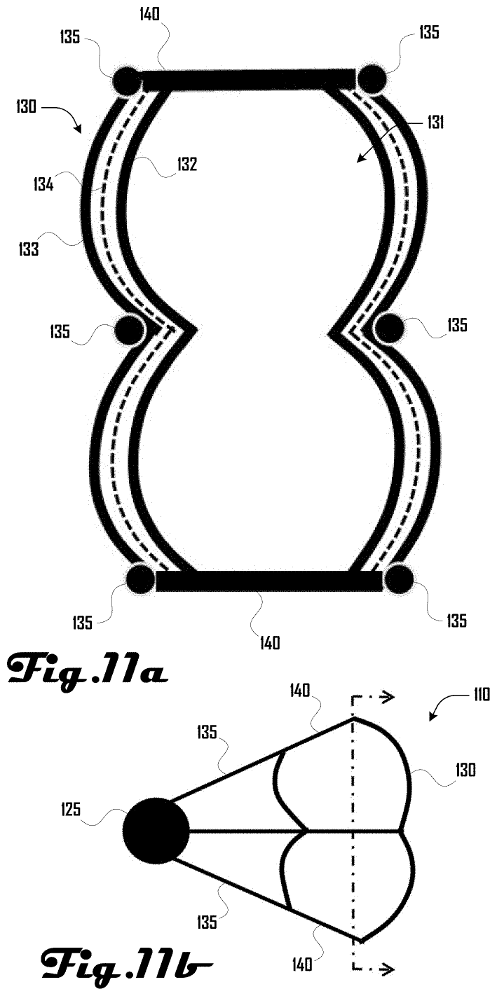

FIG. 11a illustrates a cross-sectional view of a pneumatic actuator unit 110 including bellows 130 in accordance with another embodiment and FIG. 11b illustrates a side view of the pneumatic actuator unit 110 of FIG. 11a in an expanded configuration showing the cross section of FIG. 11a. As shown in FIG. 11a, the bellows 130 can comprise an internal first layer 132 that defines the bellows cavity 131 and can comprise an outer second layer 133 with a third layer 134 disposed between the first and second layers 132, 133. Throughout this description, the use of the term ‘layer’ to describe the construction of the bellows 130 should not be viewed as limiting to the design. The use of ‘layer’ can refer to a variety of designs including but not limited to: a planar material sheet, a wet film, a dry film, a rubberized coating, a co-molded structure, and the like.

In some examples, the internal first layer 132 can comprise a material that is impermeable or semi-permeable to the actuator fluid (e.g., air) and the external second layer 133 can comprise an inextensible material as discussed herein. For example, as discussed herein, an impermeable layer can refer to an impermeable or semi-permeable layer and an inextensible layer can refer to an inextensible or a practically inextensible layer.

In some embodiments comprising two or more layers, the internal layer 132 can be slightly oversized compared to an inextensible outer second layer 133 such that the internal forces can be transferred to the high-strength inextensible outer second layer 133. One embodiment comprises a bellows 130 with an impermeable polyurethane polymer film inner first layer 132 and a woven nylon braid as the outer second layer 133.

The bellows 130 can be constructed in various suitable ways in further embodiments, which can include a single layer design that is constructed of a material that provides both fluid impermeability and that is sufficiently inextensible. Other examples can include a complex bellows assembly that comprises multiple laminated layers that are fixed together into a single structure. In some examples, it can be necessary to limit the deflated stack height of the bellows 130 to maximize the range of motion of the leg actuator unit 110. In such an example, it can be desirable to select a low-thickness fabric that meets the other performance needs of the bellows 130.

In yet another embodiment, it can be desirable to reduce friction between the various layers of the bellows 130. In one embodiment, this can include the integration of a third layer 134 that acts as an anti-abrasive and/or low friction intermediate layer between the first and second layers 132, 133. Other embodiments can reduce the friction between the first and second layers 132, 133 in alternative or additional ways, including but not limited to the use of a wet lubricant, a dry lubricant, or multiple layers of low friction material. Accordingly, while the example of FIG. 9a illustrates an example of a bellows 130 comprising three layers 132, 133, 134, further embodiments can include a bellows 130 having any suitable number of layers, including one, two, three, four, five, ten, fifteen, twenty five, and the like. Such one or more layers can be coupled together along adjoining faces in part or in whole, with some examples defining one or more cavity between layers. In such examples, material such as lubricants or other suitable fluids can be disposed in such cavities or such cavities can be effectively empty. Additionally, as described herein, one or more layers (e.g., the third layer 134) need not be a sheet or planar material layer as shown in some examples and can instead comprise a layer defined by a fluid. For example, in some embodiments, the third layer 134 can be defined by a wet lubricant, a dry lubricant, or the like.

The inflated shape of the bellows 130 can be important to the operation of the bellows 130 and/or leg actuator unit 110 in some embodiments. For example, the inflated shape of the bellows 130 can be affected through the design of both an impermeable and inextensible portion of the bellows 130 (e.g., the first and second layer 132, 133). In various embodiments, it can be desirable to construct one or more of the layers 132, 133, 134 of the bellows 130 out of various two-dimensional panels that may not be intuitive in a deflated configuration.

In some embodiments, one or more impermeable layers can be disposed within the bellows cavity 131 and/or the bellows 130 can comprise a material that is capable of holding a desired fluid (e.g., a fluid impermeable first internal layer 132 as discussed herein). The bellows 130 can comprise a flexible, elastic, or deformable material that is operable to expand and contract when the bellows 130 are inflated or deflated as described herein. In some embodiments, the bellows 130 can be biased toward a deflated configuration such that the bellows 130 is elastic and tends to return to the deflated configuration when not inflated. Additionally, although bellows 130 shown herein are configured to expand and/or extend when inflated with fluid, in some embodiments, bellows 130 can be configured to shorten and/or retract when inflated with fluid in some examples. Also, the term ‘bellows’ as used herein should not be construed to be limiting in any way. For example the term ‘bellows’ as used herein should not be construed to require elements such as convolutions or other such features (although convoluted bellows 130 can be present in some embodiments). As discussed herein, bellows 130 can take on various suitable shapes, sizes, proportions and the like.

The bellows 130 can vary significantly across various embodiments, so the present examples should not be construed to be limiting. One preferred embodiment of a bellows 130 includes fabric-based pneumatic actuator configured such that it provides knee extension torque as discussed herein. Variants of this embodiment can exist to tailor the actuator to provide the desired performance characteristics of the actuators such as a fabric actuator that is not of a uniform cross-section. Other embodiments of can use an electro-mechanical actuator configured to provide flexion and extension torques at the knee instead of or in addition to a fluidic bellows 130. Various embodiments can include but are not limited to designs that incorporate combinations of electromechanical, hydraulic, pneumatic, electro-magnetic, or electro-static for positive power or negative power assistance of extension or flexion of a lower extremity joint.

The actuator bellows 130 can also be located in a variety of locations as required by the specific design. One embodiment places the bellows 130 of a powered knee brace component located in line with the axis of the knee joint and positioned parallel to the joint itself. Various embodiments include but are not limited to, actuators configured in series with the joint, actuators configured anterior to the joint, and actuators configured to rest around the joint.

Various embodiments of the bellows 130 can include secondary features that augment the operation of the actuation. One such embodiment is the inclusion of user-adjustable mechanical hard end stops to limit the allowable range of motion to the bellows 130. Various embodiments can include but are not limited to the following extension features: the inclusion of flexible end stops, the inclusion of an electromechanical brake, the inclusion of an electro-magnetic brake, the inclusion of a magnetic brake, the inclusion of a mechanical disengage switch to mechanically decouple the joint from the actuator, or the inclusion of a quick release to allow for quick changing of actuator components.

In various embodiments, the bellows 130 can comprise a bellows and/or bellows system as described in related U.S. patent application Ser. No. 14/064,071 filed Oct. 25, 2013, which issued as U.S. Pat. No. 9,821,475; as described in U.S. patent application Ser. No. 14/064,072 filed Oct. 25, 2013; as described in U.S. patent application Ser. No. 15/823,523 filed Nov. 27, 2017; or as described in U.S. patent application Ser. No. 15/472,740 filed Mar. 29, 2017.

In some applications, the design of the fluidic actuator unit 110 can be adjusted to expand its capabilities. One example of such a modification can be made to tailor the torque profile of a rotary configuration of the fluidic actuator unit 110 such that the torque changes as a function of the angle of the joint structure 125. To accomplish this in some examples, the cross-section of the bellows 130 can be manipulated to enforce a desired torque profile of the overall fluidic actuator unit 110. In one embodiment, the diameter of the bellows 130 can be reduced at a longitudinal center of the bellows 130 to reduce the overall force capabilities at the full extension of the bellows 130. In yet another embodiment, the cross-sectional areas of the bellows 130 can be modified to induce a desired buckling behavior such that the bellows 130 does not get into an undesirable configuration. In an example embodiment, the end configurations of the bellows 130 of a rotary configuration can have the area of the ends reduced slightly from the nominal diameter to provide for the end portions of the bellows 130 to buckle under loading until the actuator unit 110 extends beyond a predetermined joint angle, at which point the smaller diameter end portion of the bellows 130 would begin to inflate.

In other embodiments, this same capability can be developed by modifying the behavior of the constraining ribs 135. As an example embodiment, using the same example bellows 130 as discussed in the previous embodiment, two constraining ribs 135 can fixed to such bellows 130 at evenly distributed locations along the length of the bellows 130. In some examples, a goal of resisting a partially inflated buckling can be combated by allowing the bellows 130 to close in a controlled manner as the actuator unit 110 closes. The constraining ribs 135 can be allowed to get closer to the joint structure 125 but not closer to each other until they have bottomed out against the joint structure 125. This can allow the center portion of the bellows 130 to remain in a fully inflated state which can be the strongest configuration of the bellows 130 in some examples.

In further embodiments, it can be desirable to optimize the fiber angle of the individual braid or weave of the bellows 130 in order to tailor specific performance characteristics of the bellows 130 (e.g., in an example where a bellows 130 includes inextensibility provided by a braided or woven fabric). In other embodiments, the geometry of the bellows 130 of the actuator unit 110 can be manipulated to allow the robotic exoskeleton system 100 to operate with different characteristics. Example methods for such modification can include but are not limited to the following: the use of smart materials on the bellows 130 to manipulate the mechanical behavior of the bellows 130 on command; or the mechanical modification of the geometry of the bellows 130 through means such as shortening the operating length and/or reducing the cross sectional area of the bellows 130.

In further examples, a fluidic actuator unit 110 can comprise a single bellows 130 or a combination of multiple bellows 130, each with its own composition, structure, and geometry. For example, some embodiments can include multiple bellows 130 disposed in parallel or concentrically on the same joint assembly 125 that can be engaged as needed. In one example embodiment, a joint assembly 125 can be configured to have two bellows 130 disposed in parallel directly next to each other. The system 100 can selectively choose to engage each bellows 130 as needed to allow for various amounts of force to be output by the same fluidic actuator unit 110 in a desirable mechanical configuration.

In further embodiments, a fluidic actuator unit 110 can include various suitable sensors to measure mechanical properties of the bellows 130 or other portions of the fluidic actuator unit 110 that can be used to directly or indirectly estimate pressure, force, or strain in the bellows 130 or other portions of the fluidic actuator unit 110. In some examples, sensors located at the fluidic actuator unit 110 can be desirable due to the difficulty in some embodiments associated with the integration of certain sensors into a desirable mechanical configuration while others may be more suitable. Such sensors at the fluidic actuator unit 110 can be operably connected to the exoskeleton device 610 (see FIG. 6) and the exoskeleton device 610 can use data from such sensors at the fluidic actuator unit 110 to control the exoskeleton system 100.

As discussed herein, various suitable exoskeleton systems 100 can be used in various suitable ways and for various suitable applications. However, such examples should not be construed to be limiting on the wide variety of exoskeleton systems 100 or portions thereof that are within the scope and spirit of the present disclosure. Accordingly, exoskeleton systems 100 that are more or less complex than the examples of FIGS. 1-5 are within the scope of the present disclosure.

Additionally, while various examples relate to an exoskeleton system 100 associated with the legs or lower body of a user, further examples can be related to any suitable portion of a user body including the torso, arms, head, legs, or the like. Also, while various examples relate to exoskeletons, it should be clear that the present disclosure can be applied to other similar types of technology, including prosthetics, body implants, robots, or the like. Further, while some examples can relate to human users, other examples can relate to animal users, robot users, various forms of machinery, or the like.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

1. An exoskeleton system comprising:
a left and right leg actuator unit configured to be respectively coupled to a left and right leg of a user, the left and right leg actuator units each including:
an upper arm and a lower arm that are rotatably coupled via a joint, the joint positioned at a knee of the user with the upper arm coupled about an upper leg portion of the user above the knee and with the lower arm coupled about a lower leg portion of the user below the knee,
a bellows actuator that extends between the upper arm and lower arm, and
one or more sets of fluid lines coupled to the bellows actuator to introduce fluid to the bellows actuator to cause the bellows actuator to expand and move the upper arm and lower arm;
a pneumatic system operably coupled to, and configured to introduce fluid to, the bellows actuators of the left and right leg actuator units via the one or more sets of fluid lines of the left and right leg actuator units;
an exoskeleton device that includes a processor and memory, the memory storing instructions, that when executed by the processor, are configured to control the pneumatic system to introduce fluid to the bellows actuators of the left and right leg actuator units;
a power system that powers the pneumatic system and the exoskeleton device, the power system including:
a first, second and third battery slot,
a first and second integral battery that are a permanent or semi-permanent part of the power system such that the first and second integral battery cannot be readily removed and coupled with power system, and
a power cord configured to couple with an obtain power from a receptacle of a building; and
a modular battery set that includes a first, second, third and fourth battery unit that are modular such that any of the first, second, third and fourth battery units can be readily and quickly removed and coupled within any of the first, second and third battery slots to provide power to the exoskeleton system.

2. The exoskeleton system of claim 1, wherein the pneumatic system, the exoskeleton device and the power system are disposed in a backpack configured to be worn by the user while operating the exoskeleton system.

3. The exoskeleton system of claim 1, wherein the power system and the first, second and third battery slots are configured for any of the first, second, third and fourth battery units to be hot-swapped, such that:
any of the first, second, third and fourth battery units can be safely removed from any of the first, second and third battery slots without powering down the exoskeleton system and while maintaining operation of the exoskeleton system, and
any of the first, second, third and fourth battery units can be safely coupled with any of the first, second and third battery slots without powering down the exoskeleton system and while maintaining operation of the exoskeleton system.

4. The exoskeleton system of claim 1, wherein the exoskeleton device is configured to:
identify whether a battery unit is, or is not, coupled to the first, second and third battery slots, and
identify a power status of one or more battery units coupled to the first, second and third battery slots,
wherein the exoskeleton device is configured to change an operating configuration of the exoskeleton system based at least in part on a number of battery units identified as being coupled to the power system via the first, second or third battery slots and based at least in part on the identified power status of the one or more battery units coupled to the first, second and third battery slot.

5. An exoskeleton system comprising:
one or more leg actuator units configured to be coupled to a leg of a user;
a pneumatic system operably coupled to, and configured to introduce fluid to, the one or more leg actuator units;
an exoskeleton device configured to control the pneumatic system to introduce fluid to the one or more leg actuator units;
a power system that powers the pneumatic system and the exoskeleton device, the power system including:
a plurality of battery slots, and
one or more integral batteries that are a permanent or semi-permanent part of the power system such that the one or more integral batteries cannot be readily removed and coupled with power system; and
a modular battery set that includes a plurality of battery units that are modular such that any of the plurality of battery units can be readily and quickly removed and coupled within any of the plurality of battery slots to provide power to the exoskeleton system.

6. The exoskeleton system of claim 5, wherein the one or more leg actuator units comprise:
an upper arm and a lower arm that are rotatably coupled via a joint, the joint positioned at a knee of the user with the upper arm coupled about an upper leg portion of the user above the knee and with the lower arm coupled about a lower leg portion of the user below the knee,
a bellows actuator that extends between the upper arm and lower arm, and
one or more sets of fluid lines coupled to the bellows actuator to introduce fluid to the bellows actuator to cause the bellows actuator to expand and move the upper arm and lower arm.

7. The exoskeleton system of claim 5, wherein the one or more integral batteries that are a permanent or semi-permanent part of the power system do not exceed a Watt-hour (Wh) rating of 100 Wh, and
wherein each of the plurality of battery units do not exceed a Watt-hour (Wh) rating of 160 Wh.

8. The exoskeleton system of claim 5, wherein the power system further comprises a power cord configured to couple with an obtain power from a receptacle external to the exoskeleton system.

9. The exoskeleton system of claim 5, wherein the plurality of battery units comprises a first, second, third and fourth battery unit.

10. The exoskeleton system of claim 5, wherein the pneumatic system, the exoskeleton device and the power system are disposed in a pack configured to be worn by the user while operating the exoskeleton system.

11. The exoskeleton system of claim 5, wherein the power system and the plurality of battery slots are configured for any of the plurality of battery units to be hot-swapped such that:
any of the plurality of battery units can be removed from any of the plurality of battery slots without powering down the exoskeleton system and while maintaining operation of the exoskeleton system, and
any of the plurality of battery units can be coupled with any of the plurality of battery slots without powering down the exoskeleton system and while maintaining operation of the exoskeleton system.

12. The exoskeleton system of claim 5, wherein the exoskeleton device is configured to:
identify whether a battery unit of the plurality of battery units is, or is not, coupled to any of the plurality of battery slots, and
identify a power status of one or more battery units coupled to at least one of the battery slots,
wherein the exoskeleton device is configured to change an operating configuration of the exoskeleton system based at least in part on a number of battery units identified as being coupled to the power system via at least one of the plurality of battery slots and based at least in part on the identified power status of the one or more battery units identified as coupled to the power system via at least one of the plurality of battery slots.

13. An exoskeleton system comprising:
a power system that powers the exoskeleton system, the power system including one or more battery slots, and
a modular battery set that includes one or more battery units that are modular such that any of the one or more battery units can be readily and quickly removed and coupled within any of the one or more battery slots to provide power to the exoskeleton system.

14. The exoskeleton system of claim 13, wherein the exoskeleton system further comprises:
one or more joint actuator units configured to be coupled to a joint of a user;
a fluid system operably coupled to, and configured to introduce fluid to, the one or more joint actuator units; and
an exoskeleton device configured to control the fluid system to introduce fluid to the one or more joint actuator units.

15. The exoskeleton system of claim 13, wherein the power system further comprises one or more integral batteries that do not exceed a Watt-hour (Wh) rating of 100 Wh.

16. The exoskeleton system of claim 13, wherein the one or more battery slots includes a first, second and third battery slot.

17. The exoskeleton system of claim 13, wherein the power system further comprises a power cord configured to couple with an obtain power from a receptacle external to the exoskeleton system.

18. The exoskeleton system of claim 13, wherein the one or more battery units comprises at least a first and second battery unit, the first battery unit not exceeding a Watt-hour (Wh) rating of 100 Wh and the second battery unit not exceeding a Watt-hour (Wh) rating of 160 Wh.

19. The exoskeleton system of claim 13, wherein the power system and the one or more battery slots are configured for any of the one or more battery units to be hot-swapped such that:
any of the one or more battery units can be removed from any of the one or more battery slots during operation of the exoskeleton system, and
any of the one or more battery units can be coupled with any of the one or more battery slots during operation of the exoskeleton system.

20. The exoskeleton system of claim 13, wherein the exoskeleton system is configured to:
identify whether a battery unit of the one or more battery units is, or is not, coupled to any of the one or more battery slots, and
wherein the exoskeleton system is configured to change an operating configuration of the exoskeleton system based at least in part on a number of battery units identified as being coupled to the power system via at least one of the one or more battery slots.
